(19) United States
(12) Patent Application Publication
(10) Pub. No.: US 2025/0036335 A1
(43) Pub. Date: Jan. 30, 2025

(54) STORAGE MEDIUM STORING PRINTER DRIVER, INFORMATION PROCESSING APPARATUS, AND METHOD OF CONTROLLING THE SAME

(71) Applicant: CANON KABUSHIKI KAISHA, Tokyo (JP)

(72) Inventor: TATSURO UCHIDA, Kanagawa (JP)

(21) Appl. No.: 18/786,292

(22) Filed: Jul. 26, 2024

(30) Foreign Application Priority Data
Jul. 28, 2023 (JP) 2023-123764

(51) Int. Cl. G06F 3/12

(52) U.S. Cl. CPC G06F 3/1252; G06F 3/1203; G06F 3/1253

(57) ABSTRACT

An information processing apparatus installs a printer driver that generates print information based on drawing data generated by an application and outputs the print information to a printing apparatus. The information processing apparatus obtains a print setting inputted via a setting screen for performing print setting, in a case where the print setting includes a spread setting, divides an original image of a page represented by the drawing data into a first image and a second image, and controls arrangement of the first image and the second image on a first sheet and a second sheet according to a binding position for binding a plurality of printed sheets using a printing material and an orientation of the original image, which are included in the print setting.

### BACKGROUND

### Field of the Disclosure

The present disclosure is related to a storage medium storing a printer driver, an information processing apparatus, and a method of controlling the same.

### Description of the Related Art

As a sheet bonding apparatus for bonding sheets together, Japanese Patent Laid-Open No. 2004-209859 describes a configuration in which sheets to which toner functioning as a bonding agent is applied are bonded to each other by thermo-compression by applying heat and pressure.

Japanese Patent Laid-Open No. 2004-289660 discloses a technique in which an original image is divided into a plurality of images, each of which is printed on a different sheet, and the original image is formed by bonding the sheets together.

By using a sheet pressure bonding apparatus or the like to bond the front and back surfaces of adjacent sheets on one side of each sheet, it is possible to create a spread product. However, conventionally, in order to perform spread printing, a dedicated printing application is used, or document preparation work, such as creating in advance images obtained by dividing an image to be printed into left and right (or top and bottom) images and placing the images on appropriate pages is required, which takes time and effort.

### SUMMARY

Embodiments of the present disclosure eliminate the above-mentioned issues with conventional technology.

A feature of embodiments of the present disclosure is to provide a technique that makes it possible to print an image created by an application as a spread.

According to embodiments of the present disclosure, there is provided a non-transitory-computer readable storage medium storing a printer driver program for causing a processor to receive drawing data from an application and generate print information, wherein the printer driver program is configured to cause the processor to: obtain a print setting inputted via a setting screen for performing print setting; in a case where the print setting includes a spread setting, divide an original image of a page represented by the drawing data into a first image and a second image; and control arrangement of the first image and the second image on a first sheet and a second sheet according to a binding position for binding a plurality of printed sheets using a printing material and an orientation of the original image, which are included in the print setting.

According to embodiments of the present disclosure, there is provided an information processing apparatus operable to generate print information based on drawing data generated by an application and output the print information to a printing apparatus, the information processing apparatus comprising: one or more controllers including one or more processors and one or more memories, the one or more controllers configured to: obtain a print setting inputted via a setting screen for performing print setting; in a case where the print setting includes a spread setting, divide an original image of a page represented by the drawing data into a first image and a second image; and control arrangement of the first image and the second image on a first sheet and a second sheet according to a binding position for binding a plurality of printed sheets using a printing material and an orientation of the original image, which are included in the print setting.

According to embodiments of the present disclosure, there is provided a method of controlling an information processing apparatus operable to generate print information based on drawing data generated by an application and output the print information to a printing apparatus, the method comprising: obtaining a print setting inputted via a setting screen for performing print setting; in a case where the print setting includes a spread setting, dividing an original image of a page represented by the drawing data into a first image and a second image; and controlling arrangement of the first image and the second image on a first sheet and a second sheet according to a binding position for binding a plurality of printed sheets using a printing material and an orientation of the original image, which are included in the print setting.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram illustrating a configuration of a printing system according to an embodiment.

FIG. 2A is a block diagram for describing a main hardware configuration of a PC according to the embodiment.

FIG. 2B is a block diagram for describing a hardware configuration of an image forming apparatus according to the embodiment.

FIG. 3A depicts a cross-sectional side view illustrating an automatic document feeder of a reading unit of the image forming apparatus according to the embodiment.

FIG. 3B depicts a schematic cross-sectional view illustrating a configuration of main components of the image forming apparatus according to the embodiment.

FIG. 4 depicts an enlarged cross-sectional view of a buffer unit of the sheet processing apparatus.

FIGS. 5A to 5F are diagrams illustrating a thermo-compression bonding operation by a thermo-compression bonding unit according to the embodiment.

FIG. 6 is a diagram illustrating an example of a toner image formed on a sheet S.

FIG. 7A is a diagram for describing an example of a print setting screen to be displayed on a display by a printer driver of the PC according to the embodiment.

FIG. 7B is a diagram for describing an example of a setting screen for designating a position at which to apply a binding method set for a binding method when a designate position button of FIG. 7A is pressed.

FIGS. 8A to 8C are diagrams illustrating an operation unit of the image forming apparatus according to the embodiment.

FIGS. 9A and 9B are diagrams for describing a print setting screen supporting a spread printing function, according to the printer driver according to the embodiment.

FIGS. 10A-10C are diagrams for describing examples of an input document for each style of spread printing, and what a print result and a final product will be for each orientation of the input document and for each setting option setting in the embodiment.

FIGS. 11A and 11B are flowcharts for explaining print information generation processing for when a printing style is single-sided, according to the printer driver according to the embodiment.

FIGS. 12A1 and 12A2 are flowcharts for explaining print information generation processing for when the printing style is double-sided, according to the printer driver according to the embodiment.

FIG. 12B is a flowchart for explaining print information generation processing for when the printing style is double-sided, according to the printer driver according to the embodiment.

FIGS. 13A1 and 13A2 are flowcharts for explaining print information generation processing for when the printing style is bookbinding, according to the printer driver according to the embodiment.

FIG. 13B is a flowchart for explaining print information generation processing for when the printing style is bookbinding, according to the printer driver according to the embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

In the present specification, assume that “image forming apparatus” broadly encompasses apparatuses that form (print) an image on a print material (print medium), such as a single function printer, a copying machine, a multifunction peripheral, and a commercial printing machine. Further, the image forming apparatus may be a system (image forming system) in which an image forming apparatus main body that forms an image on a print material and devices, such as a sheet processing apparatus and a sheet feeding apparatus, are connected to each other. Further, print materials include, for example, paper, a sheet, and a sheet of resin, such as a film.

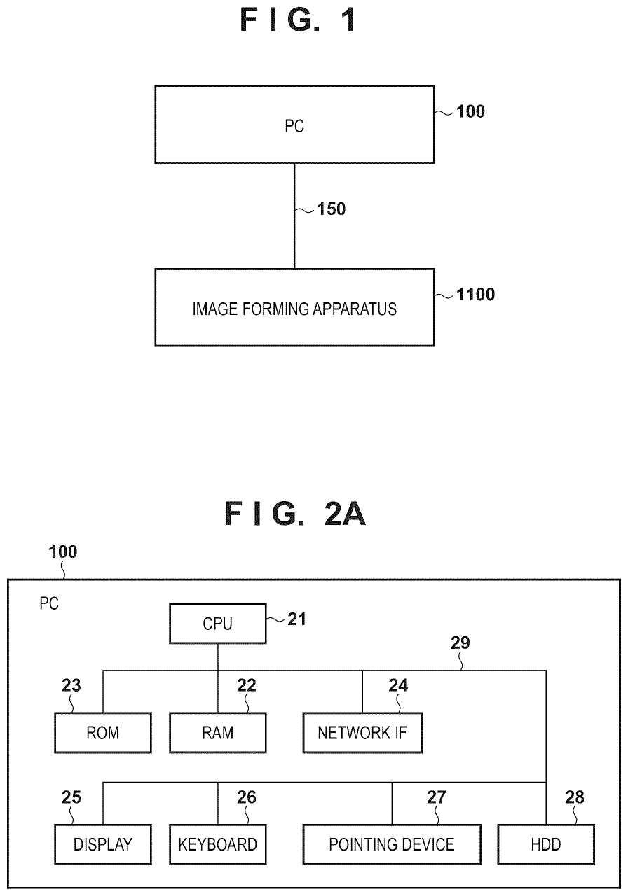

FIG. 1 is a diagram illustrating a configuration of a printing system according to an embodiment of the present disclosure.

The printing system includes a personal computer (PC) 100, which is an information processing apparatus, and an image forming apparatus 1100, and these are connected by a communication line 150, such as a local area network (LAN) or a universal serial bus (USB). The PC 100 may be, for example, a portable terminal (personal digital assistant (PDA)) or an electronic device, such as a mobile telephone. The communication line 150 is not limited to being wired and may be wireless communication.

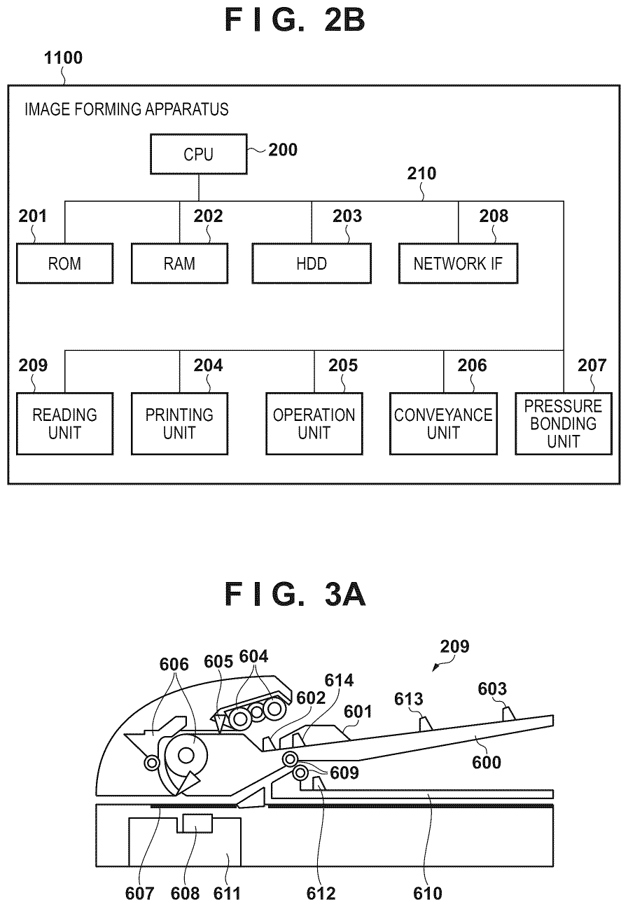

FIG. 2A is a block diagram for describing a main hardware configuration of the PC 100 according to the embodiment.

The PC 100 includes a CPU 21, a RAM 22, a ROM 23, a network interface (IF) 24, a display (display unit) 25, a keyboard 26, a pointing device 27, and a hard disk drive (HDD) 28. The CPU 21 and each of the aforementioned devices are connected via a bus 29. The CPU 21 performs control of the entire PC 100 and executes respective processes to be described later by deploying a program stored in the HDD 28 or the ROM 23 into the RAM 22 and executing the program. The RAM 22 is provided with an area for temporarily storing programs and data read and deployed from the HDD 28. The RAM 22 is also provided with a work area used for programs and data received from an external apparatus via the network IF 24 and for when the CPU 21 executes various processes. The ROM 23 stores a boot program, setting data for respective hardware devices constituting the PC 100, and the like. The network IF 24 serves as an interface unit for connecting the PC 100 to the communication line 150, and the PC 100 can perform data communication with an external apparatus via the network IF 24 and the communication line 150. The type of network IF 24 does not matter.

The display 25 includes, for example, a CRT, a liquid crystal display, and the like, and can display a processing result of the CPU 21 (e.g., print setting screen to be described later) using images, text, and the like. The keyboard 26 and the pointing device 27 are examples of typical input devices and serve as user interfaces for inputting various instructions to the CPU 21. The types of input devices are not limited thereto. In addition, when the display 25 includes a touch panel function, the display 25 also functions as an input device. The HDD 28 stores an operating system (OS), a document creation program, a printer driver to be described later, tables, and the like. The HDD 28 may be any other storage device, such as a solid state drive (SSD) so long as data can be stored therein. The PC 100 creates a document by deploying the installed operation system and respective programs in the RAM 22 and executing them, and then, when printing the document, transmits print information to the image forming apparatus 1100 through the communication line 150 via the printer driver.

FIG. 2B is a block diagram illustrating a hardware configuration of the image forming apparatus 1100 according to the embodiment.

The image forming apparatus 1100 includes a CPU 200 as a central processing unit. The CPU 200 is connected to a ROM 201, a RAM 202, an HDD 203 and a network IF 208 via a bus 210. The CPU 200 performs an image forming operation by deploying various programs stored in the ROM 201 into the RAM 202 and executing them. Various kinds of control data to be used by the CPU 200 at the time of image forming operation is stored in the RAM 202. The HDD 203 is also provided so as to hold print data. Further, a reading unit 209, a printing unit 204, an operation unit 205, a conveyance unit 206, and a pressure bonding unit 207 are connected via the bus 210. The reading unit 209 reads an image of a document and generates image data. Upon receiving a request for starting an image forming operation via the operation unit 205 or the network IF 208, the CPU 200 controls the conveyance unit 206 and the like to perform a sheet conveyance operation and controls the printing unit 204 to perform a printing operation. The CPU 200 performs copying in which the printing unit 204 performs printing based on the image data generated by the reading unit 209. Depending on the setting, the pressure bonding unit 207 is controlled to perform a sheet pressure bonding operation.

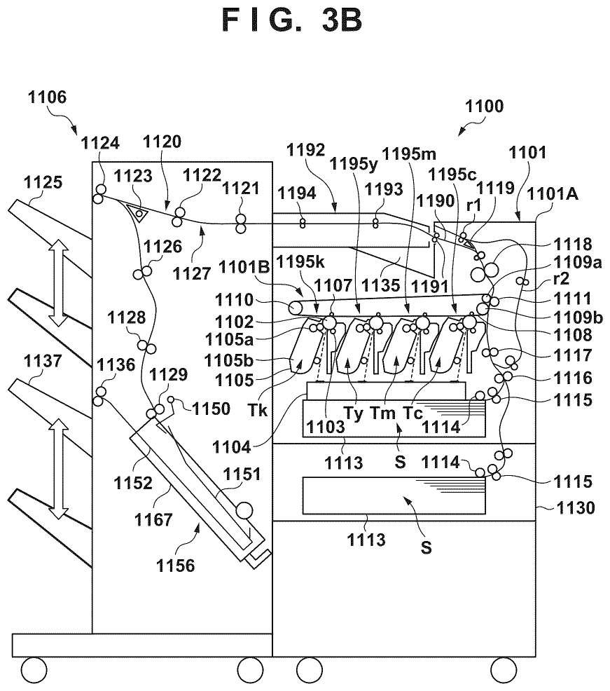

FIG. 3A depicts a cross-sectional side view illustrating an automatic document feeder of the reading unit 209 of the image forming apparatus 1100 according to the embodiment. The automatic document feeder is also referred to as an automatic document conveyance apparatus or an auto document feeder (ADF).

The automatic document feeder includes a document tray 600 for stacking documents to be read. On the document tray 600, there are two document guides 601, and also a document sensor 602 for detecting the presence or absence of a document, and three document size detection sensors 603, 613, and 614 are arranged. The document guides 601 are movable in a direction perpendicular to the document conveyance direction, and can stabilize the document conveyance by the user moving the guides until they are in contact with both main scanning direction ends of the documents placed on the document tray 600. The two document guides 601 are provided lined up in the vertical direction of the documents (perpendicular to the document conveyance direction), and a document placed on the document tray 600 is conveyed by the rotation of three rollers: pickup rollers 604, conveyance rollers 606, and discharge rollers 609. The pickup rollers 604 are rollers for conveying a document stacked on the document tray 600 into a document conveyance path inside the automatic document feeder. The conveyance rollers 606 convey the document conveyed into the document conveyance path by the pickup rollers 604, and the discharge rollers 609 convey the document conveyed by the conveyance rollers 606 to a discharge tray 610.

The discharge tray 610 is provided with a discharge tray document sensor 612 for detecting the presence or absence of a document conveyed to the discharge tray 610. Further, a document that has been conveyed by the pickup rollers 604 is detected by a document passage detection sensor 605, and it is determined whether or not a first document has passed based on the detection time. Although illustration is omitted, the conveyance rollers 606, the pickup rollers 604, and the discharge rollers 609 are all driven by a stepping motor.

The document conveyed by the automatic document feeder is caused to pass through a reading window 607 of the automatic document feeder, and is read by a contact image sensor (CIS) 608 provided in a sensor unit 611 therebelow. The sensor unit 611 can freely move in the sub-scanning direction (conveyance direction of the document), and can move in the same direction as the conveyance direction of the document conveyed from the conveyance rollers 606 toward the discharge rollers 609. Note that the reading window 607 has a certain length with respect to the sub-scanning direction, and within the scope of the length, the CIS 608 can be moved to any position and the document can be read at the moving position. The CIS 608 includes a photoelectric conversion element, such as a charge coupled device (CCD), and a first in first out (FIFO) circuit for storing image data obtained by the photoelectric conversion elements, and simultaneously generates control signals for controlling the FIFO circuit and the CCD. The CIS 608 is generally realized by arranging a plurality of photoelectric conversion elements in a row.

FIG. 3B depicts a schematic cross-sectional view illustrating a configuration of main components of the image forming apparatus 1100 according to the embodiment.

The image forming apparatus 1100 includes a printer main body 1101 as an image forming apparatus main body having an image forming function (printing function), and a sheet processing apparatus 1106 having a sheet bonding function. That is, the image forming apparatus 1100 may be an image forming system configured to include the printer main body 1101, which functions independently as an image forming apparatus, and the sheet processing apparatus 1106, which performs post-processing.

In the image forming apparatus 1100 according to the embodiment, by forming images one by one on sheets S in the printer main body 1101, and bonding a plurality of sheets S by thermo-compression in the sheet processing apparatus 1106, it is possible to create a booklet for which printing and bookbinding are performed by a single apparatus. As the sheet S, various sheet materials having different sizes and materials can be used, such as paper (e.g., plain paper or cardboard), a sheet material subjected to surface treatment (e.g., coated paper), a plastic film, a cloth, and a sheet material having a special shape (e.g., envelope or index paper).

First, a configuration of the printer main body 1101 will be described. The printer main body 1101 includes the printing unit 204 and the conveyance unit 206 of FIG. 1.

The printer main body 1101 is an electrophotographic apparatus including a housing 1101A and an electrophotographic image forming unit 1101B accommodated in the housing 1101A. The image forming unit 1101B includes an intermediate transfer belt 1108 serving as an intermediate transfer member, process cartridges disposed along the intermediate transfer belt 1108, a scanner unit 1104 serving as an exposure unit, and a primary transfer roller 1107. There are process cartridges for four colors, which are yellow 1195y, magenta 1195m, cyan 1195c, and black 1195k, each including toner which is a printing material in their respective color. In the following description, the process cartridges 1195k, 1195m, 1195c and 1195k may be shown by a process cartridge 1195.

The process cartridge 1195k uses black toner Tk to form a single color image corresponding to a black component of a color image. The process cartridge 1195y uses yellow toner Ty to form a single color image corresponding to a yellow component of a color image. The process cartridge 1195m uses magenta toner Tm to form a single color image corresponding to a magenta component of a color image. The process cartridge 1195c uses cyan toner Tc to form a single color image corresponding to a cyan component of a color image.

A process cartridge 1195 includes a photosensitive drum 1102 serving as an image carrier, a charging unit 1103, and a developing unit 1105. Although only the process cartridge 1195k is described in FIG. 3B, the process cartridge 1195y, the process cartridge 1195m, and the process cartridge 1195c have similar configurations. The single color images formed in each of the process cartridges 1195y, 1195m, 1195c, and 1195k are primary-transferred to overlap each other on the intermediate transfer belt 1108, and then secondary-transferred to the sheet at a secondary transfer portion.

The developing unit 1105 includes a developing roller 1105a and a toner container 1105b containing toner (developing agent). The developing roller 1105a is rotatably held by the toner container 1105b. Although only the developing unit 1105 in the process cartridge 1195k is described in FIG. 3B, the process cartridge 1195y, the process cartridge 1195m, and the process cartridge 1195c have similar configurations.

The process cartridges 1195y, 1195m, 1195c, and 1195k are attachable to and detachable from the housing 1101A. The housing 1101A of the printer main body 1101 refers to a part obtained by removing the process cartridge 1195 from the printer main body 1101. The housing 1101A includes a frame member such as a metal frame constituting a frame body of the printer main body 1101 and a member fixed to the frame body, and forms a mounting space in which the process cartridge 1195 is mounted.

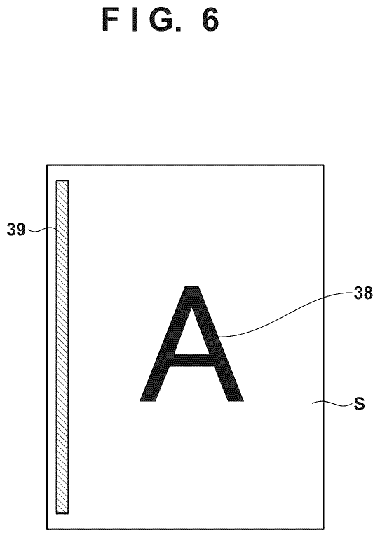

The printer main body 1101 can use at least one of the plurality of colors of toner as toner for bonding sheets to each other. For example, the black toner Tk can be used as a toner for recording images on a sheet and also as a toner for bonding. In such cases, the process cartridge 1195k generates a single color image corresponding to the black component of the color image and a toner image for bonding 39 (FIG. 6) for transfer to a bonding region of the sheet. Here, the toner for bonding is a toner having a higher bonding capability than that of a normal toner.

The scanner unit 1104 is disposed below the process cartridge 1195 in the housing 1101A. Below the scanner unit 1104, a cassette 1113 (also referred to as a sheet tray or storage compartment) serving as a storage unit for storing a sheet S used for image formation is attached to the housing 1101A such that it can be pulled out. Further, one or more optional sheet feeding units 1130 including additional cassettes 1113 may be coupled below the housing 1101A.

The intermediate transfer belt 1108 is an endless belt that can move (can rotate) and that is stretched around a drive roller 1109a, a support roller 1109b, and a tension roller 1110, which rotate about axes that are parallel to each other. The intermediate transfer belt 1108 is moved (rotated, conveyed) counterclockwise in the drawing by the rotation of the drive roller 1109a. On the inner peripheral side of the intermediate transfer belt 1108, the primary transfer roller 1107 serving as a primary transfer member is disposed at a position facing the photosensitive drum 1102 via the intermediate transfer belt 1108. A secondary transfer roller 1111 serving as a transfer member (secondary transfer member) is disposed at a position on the outer peripheral side of the intermediate transfer belt 1108 and opposed to the drive roller 1109a via the intermediate transfer belt 1108. A secondary transfer portion as a transfer portion is formed as a nip portion between the intermediate transfer belt 1108 and the secondary transfer roller 1111. The intermediate transfer belt 1108, the primary transfer roller 1107, and the secondary transfer roller 1111 constitute a transfer unit for transferring a toner image formed on the photosensitive drum 1102, which is an image carrier, to the sheet S.

A fixing unit 1118 is disposed above the secondary transfer portion in the housing 1101A. The fixing unit 1118 has a configuration of a thermal fixing method in which the toner image is fixed by heating. The fixing unit 1118 includes a pair of rotating bodies (for example, a pair of rollers including a fixing roller and a pressure roller) that sandwich and convey the sheet S, and a heat source (for example, a halogen lamp or an induction heating mechanism) that heats the toner image on the sheet S via the fixing roller.

When the printer main body 1101 performs an image forming operation, the sheet S is fed from the cassette 1113 at the lower portion of the housing 1101A or the cassette 1113 of the sheet feeding unit 1130 by the feed roller 1114. A pair of separation rollers 1115 conveys the fed sheets S while separating them one by one. The sheet S is conveyed toward a pair of registration rollers 1117 by a pair of drawing rollers 1116, and a skew of the sheet S is corrected by the leading edge of the sheet S abutting against a nip portion of the pair of registration rollers 1117 which are in a stopped state. The pair of registration rollers 1117 feeds the sheet S to the secondary transfer portion at a timing synchronized with the progress of the toner image forming process by the image forming unit 1101B.

On the other hand, in the image forming unit 1101B, the photosensitive drum 1102 and the intermediate transfer belt 1108 rotate. The charging unit 1103 uniformly charges the surface of the photosensitive drum 1102. The scanner unit 1104 writes an electrostatic latent image by irradiating the photosensitive drum 1102 with a laser beam based on image information representing an image to be recorded on the sheet S. The electrostatic latent image is developed (visualized) as a toner image by development by the developing unit 1105 using the toner.

Here, when the sheet processing apparatus 1106 performs thermo-compression bonding to be described later, the scanner unit 1104 irradiates the photosensitive drum 1102 with a laser beam to write an electrostatic latent image on the basis of information indicating the bonding position of the sheet S. The electrostatic latent image is developed by the developing unit 1105 in the process cartridge 1195k using toner, so that a toner image for bonding is formed in a region on the photosensitive drum 1102 corresponding to the bonding position on the sheet S.

The single color images formed in the photosensitive drum 1102 of each of the process cartridges 1195y, 1195m, 1195c, and 1195k are primary-transferred to overlap each other on the intermediate transfer belt 1108. Thereafter, the intermediate transfer belt 1108 is conveyed toward the secondary transfer portion by rotation. When a voltage is applied to the secondary transfer roller 1111 in the secondary transfer portion, the toner image is transferred (secondarily transferred) to the sheet S fed from the pair of registration rollers 1117. The sheet S, after passing through the secondary transfer portion, is sent to the fixing unit 1118, and the toner image is heated and pressed while passing through the nip portion of the fixing roller and the pressure roller to soften the toner, and then solidify it, whereby the image is affixed to the sheet S.

The conveyance path of the sheet S, after it has passed through the fixing unit 1118, is switched by a switching unit 1119. In single-sided printing, the sheet S is guided to a discharge path 1190 by the switching unit 1119, and is discharged from the housing 1101A by a pair of discharge rollers 1191. In the present embodiment, the printer main body 1101 is connected to the sheet processing apparatus 1106 via a relay conveyance unit 1192. The sheet S, after being discharged from the pair of discharge rollers 1191, is transferred to the sheet processing apparatus 1106 via the pair of conveyance rollers 1193 and 1194 of the relay conveyance unit 1192. When the relay conveyance unit 1192 and the sheet processing apparatus 1106 are not connected to each other, the pair of discharge rollers 1191 discharges the sheet S as a product to a stacking tray 1135 provided in the upper portion of the housing 1101A.

In double-sided printing, the sheet S, after an image is formed on the first surface thereof, is guided to a pair of reversing rollers r1 by the switching unit 1119. Then, the sheet S is inversely conveyed (switchback conveyance) by the pair of reversing rollers r1, and then conveyed toward the pair of registration rollers 1117 via a double-sided conveyance path r2. Then, the sheet S is discharged from the housing 1101A by the pair of discharge rollers 1191 after an image is formed on the second surface on the opposite side of the first surface, by passing through the secondary transfer portion and the fixing unit 1118.

FIG. 6 is a diagram illustrating an example of a toner image formed on a sheet S.

In the illustrated sheet S, a toner image (toner image for printing) 38 for printing an image such as text, a figure, or a photograph and a toner image (toner image for bonding) 39 for bonding sheets to each other are formed. Here, the position, shape, width, and the like of the toner image 39 for bonding can be changed in accordance with the configuration of a thermo-compression bonding unit 1167 described later.

When the image forming apparatus 1100 creates a single-sided printed booklet, the toner image 39 for bonding is formed on only one side of the sheet S (the same surface as the toner image for printing). In the case of a booklet of double-sided printing, the toner image 39 for bonding may be formed only on one side of the sheet S, or may be formed on both sides of the sheet S.

Next, the configuration of the sheet processing apparatus 1106 will be described.

The sheet processing apparatus 1106 includes a buffer unit 1120 for stacking a plurality of sheets S, an alignment unit 1156 for aligning the plurality of sheets S, and the thermo-compression bonding unit 1167 for bonding the sheets S to each other by thermo-compression. The thermo-compression bonding unit 1167 corresponds to the pressure bonding unit 207 of FIG. 1, and is an example of a sheet bonding apparatus (bonding unit, thermo-compression bonding unit, bonding processing unit) for bonding the sheets to each other. Further, the sheet processing apparatus 1106 includes an upper discharge tray 1125 and a lower discharge tray 1137 that can be raised and lowered, respectively, as discharge destinations for discharging products of the image forming apparatus 1100.

The sheet processing apparatus 1106 is a sheet processing apparatus that receives a plurality of sheets S on which images are formed one by one by the printer main body 1101, performs bonding processing (thermo-compression bonding), and discharges the sheets as a sheet bundle (booklet). The buffer unit 1120, the alignment unit 1156, and the thermo-compression bonding unit 1167 will be described later in detail. The sheet processing apparatus 1106 can also discharge the sheet S after an image has been formed thereon by the printer main body 1101 to the upper discharge tray 1125 or the lower discharge tray 1137 without performing processing.

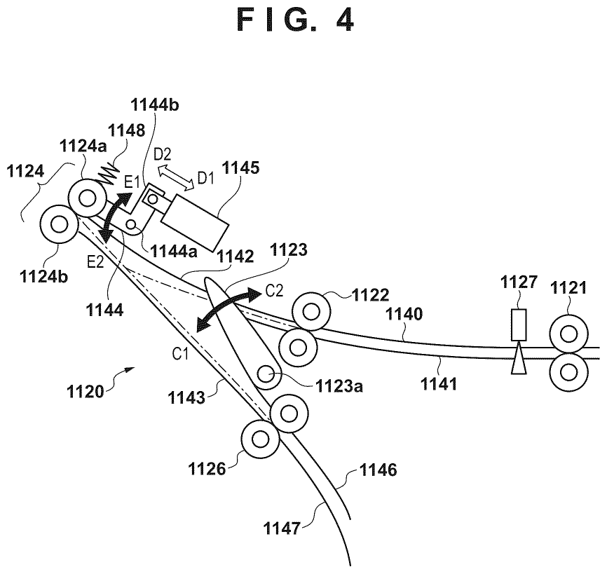

Next, a configuration of the buffer unit 1120 will be described with reference to FIGS. 3B and 4. FIG. 4 depicts an enlarged cross-sectional view of the buffer unit 1120.

The buffer unit 1120 includes a pair of entrance rollers 1121, a pair of pre-buffer rollers 1122, a check valve 1123, a pair of reversing rollers 1124, and a pair of inner discharge rollers 1126. In addition, the buffer unit 1120 includes a separation mechanism including an entrance sensor 1127 for detecting a sheet and a plunger solenoid 1145 and the like for opening and closing (bringing into contact and separating) the pair of reversing rollers 1124.

Each of the pair of entrance rollers 1121, the pair of pre-buffer rollers 1122, the pair of reversing rollers 1124, and the pair of inner discharge rollers 1126 is a pair of rollers that sandwiches and conveys a sheet. The pair of entrance rollers 1121 and the pair of pre-buffer rollers 1122 are arranged in a conveyance path (entrance path) for the sheet processing apparatus 1106 to receive the sheet S. The pair of reversing rollers 1124 is disposed in a conveyance path (first discharge path, refer to FIG. 3B) communicating with the upper discharge tray 1125. The pair of inner discharge rollers 1126 is disposed in a conveyance path (inner discharge path, refer to FIG. 3B) from the pair of reversing rollers 1124 toward the thermo-compression bonding unit 1167. The sheet processing apparatus 1106 includes a conveyance path (second discharge path, refer to FIG. 3B) from the thermo-compression bonding unit 1167 toward the lower discharge tray 1137.

The entrance path is formed by an upper entrance guide 1140 and a lower entrance guide 1141 of FIG. 4. A first discharge path is formed by an upper inverting guide 1142 and a lower inverting guide 1143. An inner discharge path is formed by an upper inner discharge guide 1146 and a lower inner discharge guide 1147. The entrance sensor 1127 is arranged to detect a sheet received by the pair of entrance rollers 1121. The entrance sensor 1127 may use, for example, a reflective photosensor that irradiates infrared light toward an entrance path through an opening provided in the upper entrance guide 1140 and detects light reflected from a sheet to determine the presence or absence of the sheet S. The lower entrance guide 1141 may be provided with a hole having a spot diameter or more of the infrared light emitted from the entrance sensor 1127 so as not to reflect infrared light when no sheet is passing through the entrance path.

The check valve 1123 is disposed downstream of the pair of pre-buffer rollers 1122 in the sheet conveyance direction in the entrance path. The check valve 1123 is rotatably disposed about the rotational shaft 1123a with respect to the upper inner discharge guide 1146. The check valve 1123 can move between a first position for preventing the sheet from moving (backflow) from the first discharge path to the entrance path and a second position for allowing the sheet to move from the entrance path to the first discharge path. The check valve 1123 is biased in a C2 direction from the second position toward the first position by a spring (not illustrated). The check valve 1123 is configured to be pressed by the sheet to move in the C1 direction from the first position toward the second position, and return to the first position when the sheet passes.

When viewed in the direction of the rotation axis of the check valve 1123, the distal end portion of the check valve 1123 in the first position overlaps with the upper inverting guide 1142. In addition, the distal end portion of the check valve 1123 is formed in a comb-like shape so as to enable overlap with the upper inverting guide 1142. Further, when viewed in the direction of the rotation axis of the check valve 1123, a space through which the sheet can pass is formed between the check valve 1123 at the second position and the upper inverting guide 1142.

The pair of reversing rollers 1124 includes an upper reversing roller 1124a and a lower reversing roller 1124b, and drive is supplied to both rollers. The rotations of the upper reversing roller 1124a and the lower reversing roller 1124b are configured to be constantly synchronized. Further, a removing lever 1144 is connected to the upper reversing roller 1124a. The removing lever 1144 is rotatably supported about a lever fulcrum shaft 1144a with respect to the upper inverting guide 1142. The removing lever 1144 is rotatably connected to the plunger solenoid 1145 in a solenoid connection shaft 1144b.

When a current flows through the plunger solenoid 1145, the core moves in a D1 direction in the drawing, so that the removing lever 1144 rotates in an E1 direction in the drawing. In such a case, the pair of reversing rollers 1124 is in a separated state (a state in which the nip portion is opened) in which the upper reversing roller 1124a and the lower reversing roller 1124b are separated from each other. In a case where the current flowing through the plunger solenoid 1145 is stopped, the upper reversing roller 1124a moves in an E2 direction due to the biasing force of a pressurizing spring 1148, and the core of the plunger solenoid 1145 moves in a D2 direction. In such a case, the pair of reversing rollers 1124 is in a contact state (a state in which the nip portion is formed) in which the upper reversing roller 1124a and the lower reversing roller 1124b are in contact with each other.

As described below, the buffer unit 1120 performs an operation of stacking the newly conveyed sheet on the sheets (bundle) while reciprocating the sheets (bundle) between the pair of reversing rollers 1124 and the pair of inner discharge rollers 1126. By this operation, the buffer unit 1120 can send a predetermined number of sheets at a time (for example, five sheets) to the alignment unit 1156 in a stacked state.

As illustrated in FIG. 3B, a sheet bundle stacked in the buffer unit 1120 is conveyed from the pair of inner discharge rollers 1126 to a pair of kick-out rollers 1129 via a pair of intermediate conveyance rollers 1128. Then, the sheet bundle is conveyed by the pair of kick-out rollers 1129 to the alignment unit 1156 (intermediate stacking portion, processing stage) including an upper intermediate guide 1151 and a lower intermediate guide 1152, and the like. Further, downstream of the pair of kick-out rollers 1129, a bundle pressing flag 1150 for suppressing the lifting of the trailing edge of the stacked sheets is arranged so that the trailing edge of the sheets already stacked on the alignment unit 1156 and the leading edge of the subsequent sheet conveyed to the alignment unit 1156 do not interfere with each other.

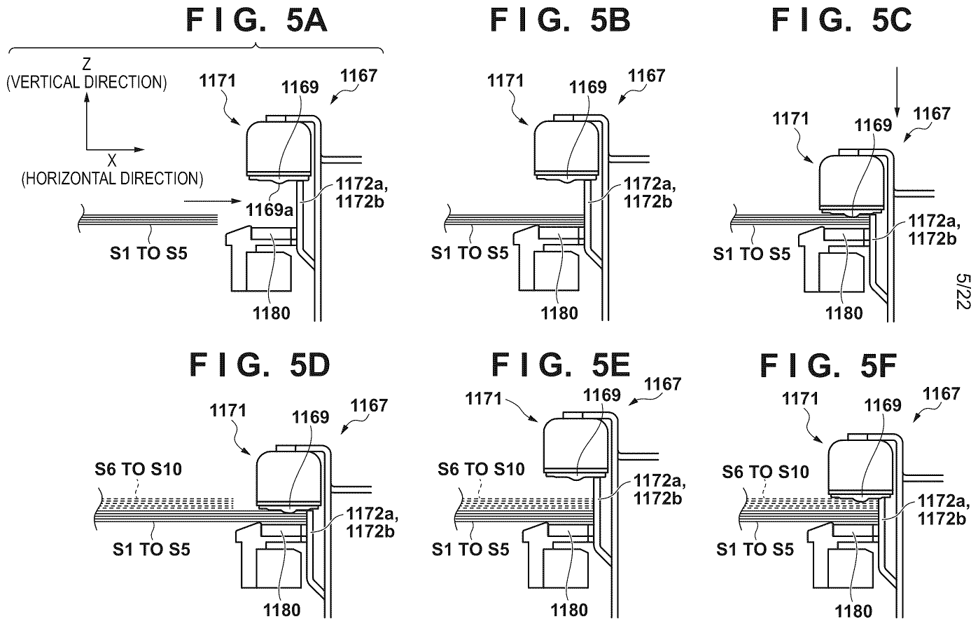

FIGS. 5A to 5F are diagrams for describing a thermo-compression bonding operation by a thermo-compression bonding unit 1167 according to the embodiment. Each of FIGS. 5A to 5F is a diagram of the thermo-compression bonding unit 1167 viewed in the sheet conveyance direction (Y direction).

FIG. 5A is illustrates a state in which alignment of the sheets S1 to S5 in the sheet conveyance direction (Y direction) is completed. In this state, a heater unit 1171 is at a position separated from the sheet bundle in a Z direction.

FIG. 5B illustrates a state in which alignment of the sheets S1 to S5 in the widthwise direction is completed. The sheets S1 to S5 are aligned in the sheet width direction (X direction) by abutting against the width alignment reference plates 1172a and 1172b.

FIG. 5C illustrates a state in which the heater unit 1171 is moved in the pressurizing direction (−Z side) by the forward rotation of a motor, and a contacting surface 1169a of a pressurizing plate 1169 is brought into contact with the uppermost sheet S5.

FIG. 5D illustrates a state in which, by the driving of the motor being continued, the sheets S1 to S5 are sandwiched between the pressurizing plate 1169 and a receiving plate 1180, and thermo-compression bonding of the sheets S1 to S5 is ongoing. Further, FIG. 5D illustrates a state in which, in parallel to the thermo-compression bonding of the sheets S1 to S5, subsequent sheets S6 to S10 have been conveyed to the alignment unit 1156.

FIG. 5E illustrates a state in which, after the thermo-compression bonding of the sheets S1 to S5 is completed, the heater unit 1171 is moved (retracted) to the opposite side (+Z side) in the pressurizing direction by the reverse rotation of the motor, and the pressurizing plate 1169 is separated from the sheet S5. Further, FIG. 5E illustrates a state in which alignment of the subsequent sheets S6 to S10 is performed, and the sheets S6 to S10 are brought into contact with the width alignment reference plates 1172a and 1172b after the heater unit 1171 is retracted.

FIG. 5F illustrates a state in which the heater unit 1171 moves again in the pressurizing direction (−Z side) by the forward rotation of the motor, the sheets S1 to S10 are sandwiched between the pressurizing plate 1169 and the receiving plate 1180, and thermo-compression bonding of the sheets S6 to S10 is ongoing. Here, since the toner image for bonding is formed on the upper surface of the sheet S5 and/or the lower surface of the sheet S6, the sheet bundle made of the sheets S1 to S5 and the sheet bundle made of the sheets S6 to S10 are bonded by thermo-compression.

As described above, the thermo-compression bonding unit 1167 performs one thermo-compression bonding operation each time a predetermined number of sheet bundles are aligned by the alignment unit 1156, so that a booklet including more than a predetermined number of sheets can be created. Although an example in which a booklet comprising ten sheets S1 to S10 is prepared has been described here, the present disclosure is not limited thereto, and a booklet made of several tens of sheets or more may be prepared.

When thermo-compression bonding on all the sheets constituting parts of the booklet is completed, the booklet comprising the sheets S1 to S10 is pushed out by the vertical alignment reference plate, and the booklet is conveyed in a direction toward a pair of bundle discharge rollers 1136 (FIG. 3B) in the sheet conveyance direction (−Y side). In other words, the vertical alignment reference plate is an example of a pushing member that pushes out the sheet bundle from the alignment unit 1156 and the thermo-compression bonding unit 1167. In addition, a pushing member for pushing out the processed sheet bundle may be provided separately from the vertical alignment reference plate as a reference for aligning the sheet bundle.

The pair of bundle discharge rollers 1136 is a pair of rollers that can be opened and closed (can come into contact and separate), and receives the booklet in a separated state. After the leading edge of the booklet in the direction in which the vertical alignment reference plate pushes out the booklet exceeds the position of the pair of bundle discharge rollers 1136, the movement of the vertical alignment reference plate is stopped, and the pair of bundle discharge rollers 1136 is switched to the contact state. As a result, the pair of bundle discharge rollers 1136 sandwiches and conveys the booklet, and discharges the booklet to the lower discharge tray 1137. Meanwhile, the vertical alignment reference plate returns to the standby position again after transferring the booklet to the pair of bundle discharge rollers 1136.

As described above, according to the configuration of the embodiment, it is possible to provide a sheet bonding apparatus, a sheet processing apparatus, and an image forming apparatus capable of more stably bonding sheets to each other.

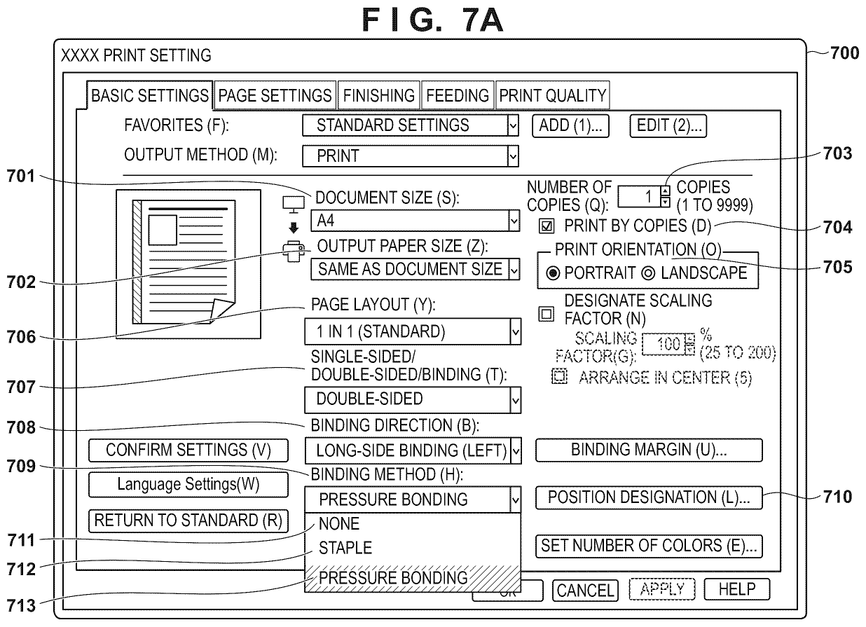

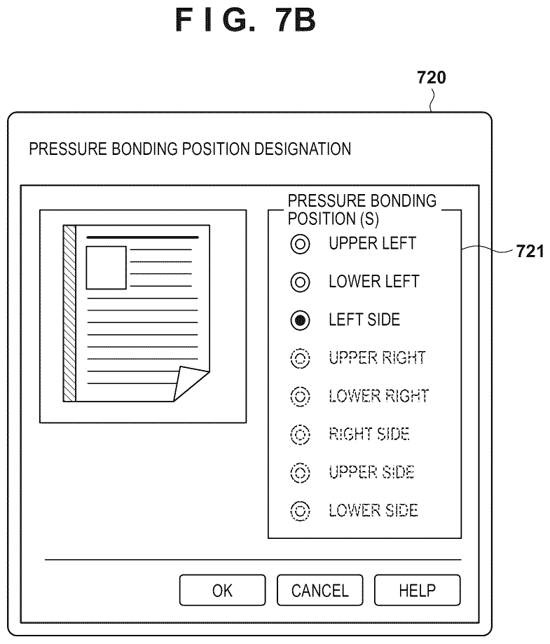

FIG. 7A is a diagram illustrating an example of a print setting screen 700 to be displayed on the display 25 by a printer driver of the PC 100 according to the embodiment.

The printer driver is a print control program installed in the PC 100, and is executed by the CPU 21. The printer driver is also called from a document program installed on the PC 100 to generate print information comprising a print setting command for performing printing and a drawing data command for printing. The print information generated by the CPU 21 using the printer driver is similarly transmitted by the CPU 21 to the image forming apparatus 1100 connected via the communication line 150 using the operating system (OS), and then print processing and sheet processing are performed. The print setting screen 700 is displayed on a display device such as the display 25 based on an instruction from the CPU 21, and a user performs print settings using an input device such as a pointing device or a keyboard via the screen.

The print setting screen 700 provides basic print settings such as a document size 701, a sheet size 702, a number of copies 703, print by copies 704, and a print orientation 705. Further, as an extended printing function, it is possible to set a page layout 706 for setting allocation printing and the like, single-sided/double-sided/bookbinding 707 for setting single-sided, double-sided, bookbinding printing and the like, a binding direction 708 for setting a binding direction of a printed matter, and the like. Further, the print setting screen 700 has control of a binding method 709 for setting a binding method for a printed matter. The print setting screen 700 of FIG. 7A illustrates a screen at the time of setting of the binding method 709 for when the binding direction 708 is “long-side binding (left-side binding)”. Here, in addition to “none” 711 in which binding processing is not performed and “stapling” 712 in which stapling is performed, it is possible to set “pressure bonding” 713 or performing thermo-compression bonding.

FIG. 7B is a diagram illustrating an example of a setting screen to be displayed on the display 25 based on an instruction of the CPU 21 when the position designation 710 button of FIG. 7A is pressed and for designating a position at which to apply the binding method set in the binding method 709.

When the binding direction 708 is “long-side binding (left-side binding)” and pressure bonding 713 is set in the binding method 709, a pressure bonding position designation screen 720 as illustrated in FIG. 7B is displayed. On pressure bonding position designation screen 720, the user can set a left-side binding pressure bonding position 721. Here, radio buttons for the pressure bonding positions that can be set are displayed in an enabled state, and radio buttons for the pressure bonding positions that cannot be set are displayed in a disabled state. The user selects and designates a desired pressure bonding position from among the pressure bonding position radio buttons in the enabled state. In the example of FIG. 7B, a state in which three positions, upper left, lower left, and left side, are enabled and can be set and “left side” is selected is illustrated. On the position designation screen 720, a pressure bonding portion corresponding to the left side is displayed in a mesh pattern.

When pressure bonding 713 is set in the binding method 709, the CPU 21 uses the printer driver to write a command to perform thermo-compression bonding at the position selected in the pressure bonding position 721 of FIG. 7B in the print information. As a result, the pressure bonding unit 207 of the image forming apparatus 1100, which has received the print information, performs pressure bonding processing at the pressure bonding position.

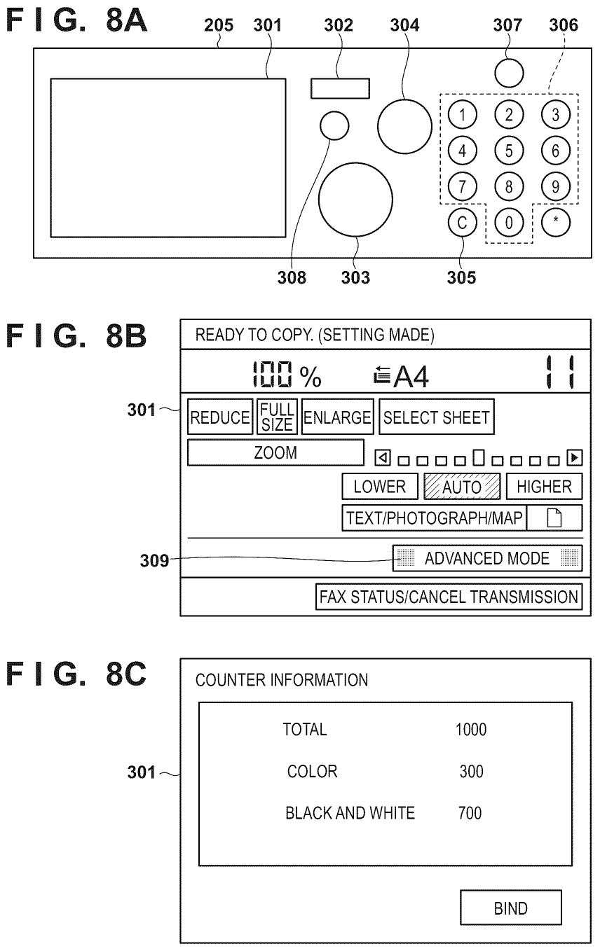

FIGS. 8A to 8C are diagrams illustrating an operation unit 205 of the image forming apparatus 1100 according to the embodiment.

The user can input and set various conditions and information to the image forming apparatus 1100 via the operation unit 205. FIG. 8A depicts a top view of the operation unit 205. A display unit 301 is a touch panel display, and can display, for example, a menu screen for copying as illustrated in FIG. 8B. In this menu screen, the number of copies, the selected sheet size, the scaling factor, copying density are displayed. When an advanced mode 309 of this screen is pressed, a screen in which various settings of the copy job can be made is transitioned to.

In FIG. 8A, a reset key 302 is used to return various settings of the copy mode to those of a standard mode. A start key 303 instructs the start of the copy operation. A stop key 304 is used to interrupt the copy operation. A clear key 305 returns the copy mode to the standard mode. A numeric keypad 306 is numeric value input keys for setting the number of copies and the like. When a user mode key 307 is pressed, a menu can be selected, and various settings for the image forming apparatus 1100 can be registered. When a counter key 308 is pressed, the display of the touch panel display 301 becomes a screen such as FIG. 8C, and various counter information can be viewed. In FIG. 8C, the total number of color prints, the total number of monochrome prints, and the sum total thereof are displayed. The touch panel display 301 is also used to notify the user of information such as paper jam information and toner information.

In the embodiment, a tandem-type color printer configuration including four process cartridges has been given as an example, but there may be five or more or three or less types of toner. Further, instead of a configuration in which at least one of a plurality of colors of toner is used as both toner for printing an image on a sheet and toner for bonding, a configuration in which toner dedicated to bonding is used may be taken. In this case, in a process cartridge in which toner dedicated to bonding is used, only the toner image for bonding 39 (FIG. 6) is formed.

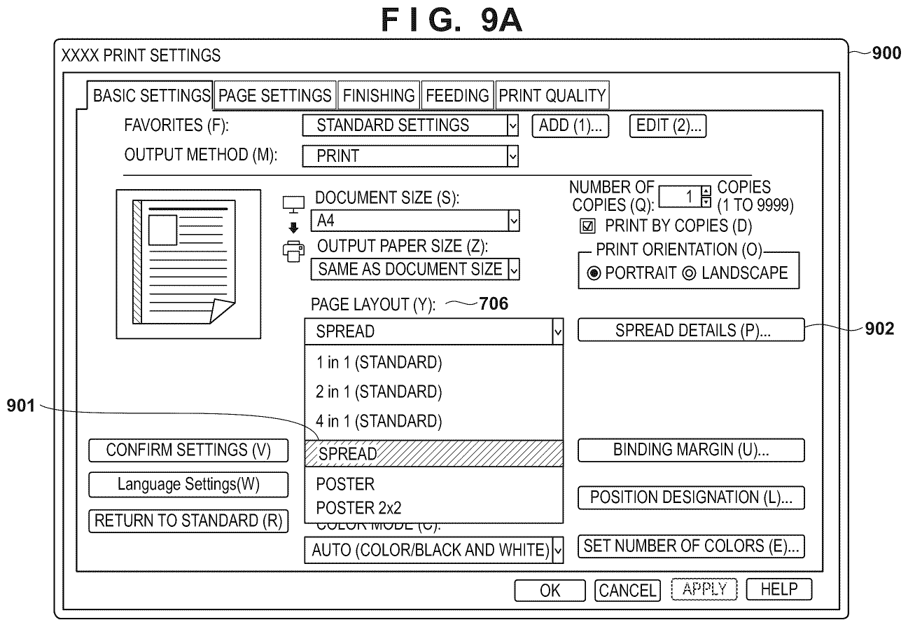

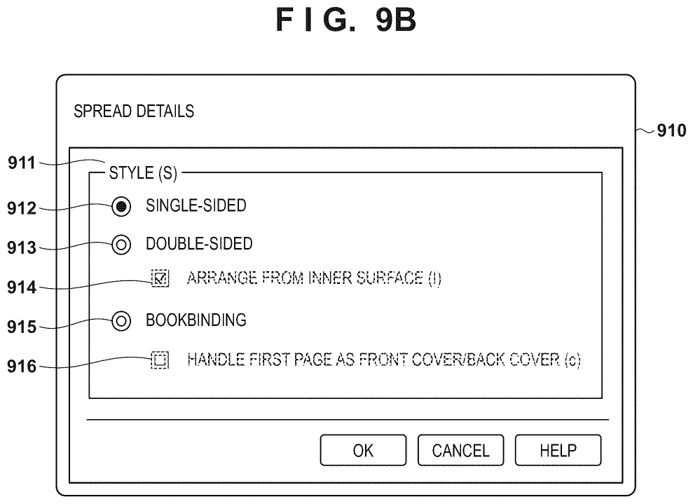

FIGS. 9A and 9B are diagrams illustrating a print setting screen 900 supporting a spread printing function, according to the printer driver according to the embodiment.

FIG. 9A illustrates a print setting screen 900, and FIG. 9B illustrates an example of a spread detail setting screen 910. The print setting screen 900 of FIG. 9A is the same as the print setting screen 700 of FIG. 7 described above except for what is related to spreads. The print setting screen 900 is displayed on a display device such as the display 25 based on an instruction from the CPU 21 of the PC 100, and a user performs print settings using an input device such as the pointing device 27 or the keyboard 26 via the screen.

In the embodiment, as illustrated in FIG. 9A, the page layout 706 is provided with a setting for a spread 901 and a spread details button 902 for calling a screen for performing advanced settings for spread printing.

When the spread 901 is set in the page layout 706, although details will be described later, control is performed to divide and arrange an original image on the respective surfaces of two sheets that constitute a spread when successive sheets are bound on one side.

FIG. 9B illustrates the spread detail setting screen 910 to be displayed on a display device, such as the display 25, based on an instruction of the CPU 21 when the spread details button 902 of FIG. 9A is pressed. In the spread detail setting screen 910, a spread printing style 911 is to be selected from among single-sided 912, double-sided 913, and bookbinding 915, each of whose details will be described later. Further, a checkbox 914 for setting whether to perform arrangement from an inner surface when the style 911 is double-sided 913 is provided. Further, a checkbox 916 for setting whether the first page is treated as a front cover or a back cover when the style 911 is bookbinding 915 is provided. By providing these option settings, it is possible to handle various forms of spread printing.

Next, modes of printing for each style of spread printing will be described.

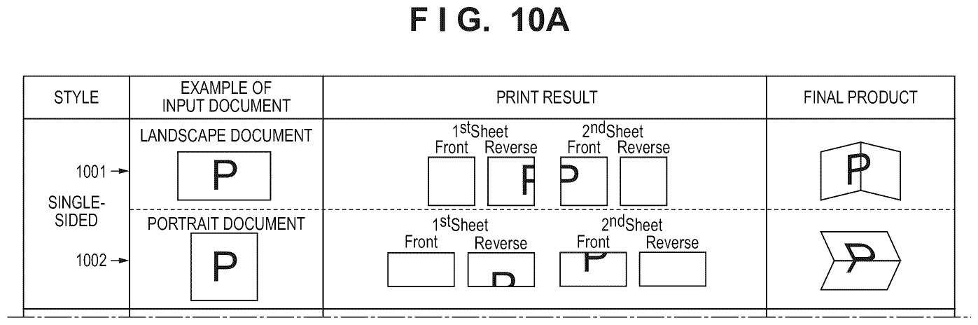

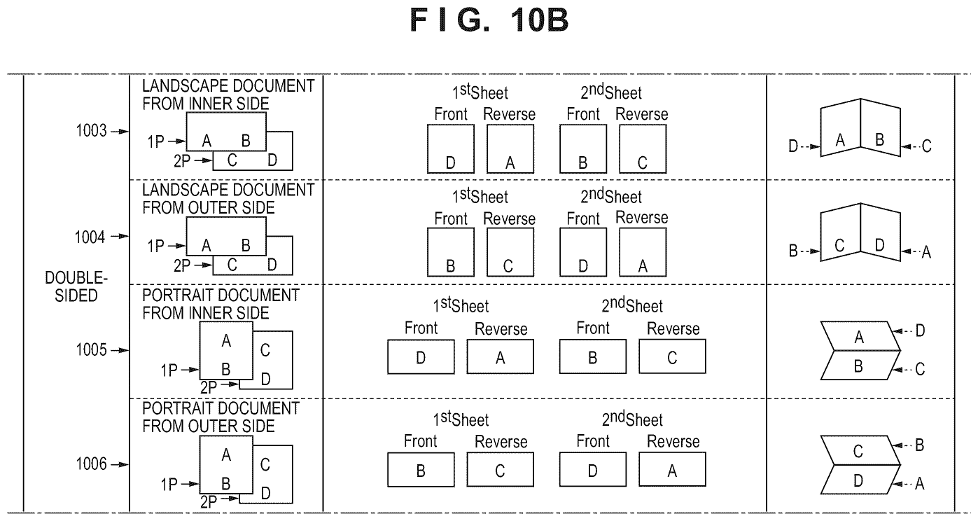

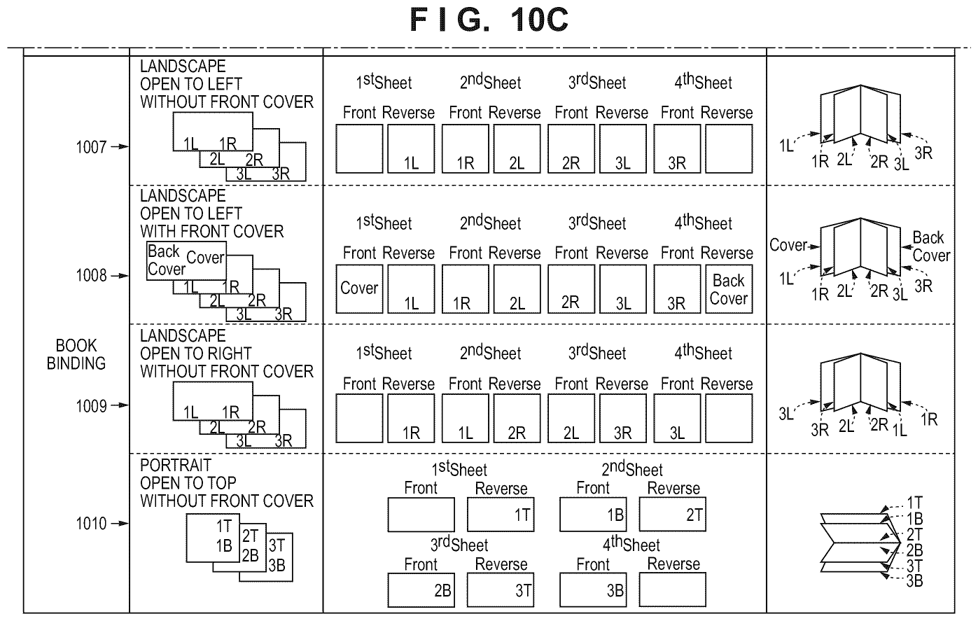

FIGS. 10A-10C are diagrams for describing examples of an input document for each style of spread printing, and what a print result and a final product will be for each orientation of the input document and for each setting option setting in the embodiment. Print results of FIGS. 10A-10C illustrate states of sheets to be outputted from the image forming apparatus 1100 and are not states of sheets to be outputted from the sheet processing apparatus 1106. Further, in the configuration of the embodiment, final products illustrate states of sheets to be outputted from the sheet processing apparatus 1106, but sheet processing such as pressure bonding may be performed off-line.

FIGS. 10A-10C illustrate a print result and a final product for each case of an orientation of an input document, a binding direction, an arrangement order, and presence or absence of a front cover, in each of single-sided, double-sided, and bookbinding of the printing style 911 of FIG. 9B when spread printing is set. The gray on sides of print results and final products illustrates sides on which respective sheets are bound, and when the sheet processing apparatus 1106 for performing thermo-compression bonding is mounted, thermo-compression bonding is performed at this position.

First, an example in which an image of an input document is divided into two and sheets on which the respective images have been printed on one side are bound as a spread will be described.

An example of reference numeral 1001 illustrates a case where the printing style 911 is single-sided 912, an input document is landscape, and left-side binding is performed. It is illustrated that, in this case, the left half of an original image is printed so as to be arranged on the back surface of the first sheet, and the right half of the original image is printed so as to be arranged on the front surface of the second sheet, and that when the two sheets are then bound with left-side binding, a product in which the original image of the input document is arranged on the left and right of a spread surface is obtained as illustrated by the final product. Although not illustrated in FIG. 10A, in the case of right-side binding, it may be that left and right are switched, and the right half of an original image is printed so as to be arranged on the back surface of the first sheet and the left half of the original image is printed so as to be arranged on the front surface of the second sheet.

An example of reference numeral 1002 illustrates a case where the printing style 911 is single-sided 912, an input document is portrait, and top binding is performed. It is illustrated that, in this case, the top half of an original image is printed so as to be arranged on the back surface of the first sheet, and the bottom half of the original image is printed so as to be arranged on the front surface of the second sheet, and that when the two sheets are then bound with top binding, a product in which the original image of the input document is arranged on the top and bottom of a spread surface is obtained as illustrated by the final product.

Here, an example in which the original image is one page is illustrated, but when the printing style 911 is single-sided 912 and there are a plurality of original images, the above-described division and arrangement of an original image and printing are repeated for each page.

Next, an example in which respective images of two input documents are divided into two and two sheets on which the images have been printed on both sides are bound as a spread will be described.

An example of reference numeral 1003 in FIG. 10B illustrates a case where the printing style 911 is double-sided 913, input documents are landscape, “arrange from inner surface” is instructed due to the checkbox 914 being checked, and left-side binding is performed. It is illustrated that, in this case, the right half (D) of an image on the second page of original images is printed so as to be arranged on the front surface of the first sheet, and the left half (A) of an image on the first page of the original images is printed so as to be arranged on the back surface thereof, that then the right half (B) of the image on the first page of the original images is printed so as to be arranged on the front surface of the second sheet, and the left half (C) of the image on the second page of the original images is printed so as to be arranged on the back surface thereof, and that when the two sheets thus obtained are bound with left-side binding, a product in which the image on the first page of the original images is arranged on the entire inner surface of a left and right spread, and the image on the second page of the original images is arranged on the outer surface is obtained as illustrated by the final product. Although not illustrated in FIG. 10B, in the case of right-side binding, it may be that left and right are switched, the left half (C) of the image on the second page of the original images is printed so as to be arranged on the front surface of the first sheet, and the right half (B) of the image on the first page of the original images is printed so as to be arranged on the back surface thereof, and that then the right half (A) of the image on the first page of the original images is printed so as to be arranged on the front surface of the second sheet, and the left half (D) of the image on the second page of the original images is printed so as to be arranged on the back surface thereof.

An example of reference numeral 1004 illustrates a case where the printing style 911 is double-sided 913, input documents are landscape, “arrange from outer surface” is performed instead of “arrange from inner surface” due to the checkbox 914 not being checked, and left-side binding is performed. It is illustrated that, in this case, compared to the case of reference numeral 1003, the first page and the second page of original images are switched, the right half (B) of an image on the first page of the original images is printed so as to be arranged on the front surface of the first sheet, and the left half (C) of an image on the second page of the original images is printed so as to be arranged on the back surface thereof, that then the right half (D) of the image on the second page of the original images is printed so as to be arranged on the front surface of the second sheet, and the left half (A) of the image on the first page of the original images is printed so as to be arranged on the back surface thereof, and that when the two sheets thus obtained are bound with left-side binding, a product in which the image on the second page of the original images is arranged on the entire inner surface of a left and right spread, and the image on the first page of the original images is arranged on the outer surface is obtained as illustrated by the final product. Although not illustrated in FIG. 10B, in the case of right-side binding, it may be that left and right are switched, the left half (A) of the image on the first page of the original images is printed so as to be arranged on the front surface of the first sheet, and the right half (D) of the image on the second page of the original images is printed so as to be arranged on the back surface thereof, and that then the right half (C) of the image on the second page of the original images is arranged on the front surface of the second sheet, and the left half (B) of the image on the first page of the original images is arranged on the back surface thereof.

An example of reference numeral 1005 illustrates a case where the printing style 911 is double-sided 913, input documents are portrait, “arrange from inner surface” is performed due to the checkbox 914 being checked, and top binding is performed. It is illustrated that, in this case, the bottom half (D) of an image on the second page of original images is printed so as to be arranged on the front surface of the first sheet, and the top half (A) of an image on the first page of the original images is printed so as to be arranged on the back surface thereof, that then the bottom half (B) of the image on the second page of the original images is printed so as to be arranged on the front surface of the second sheet, and the top half (C) of the image on the first page of the original images is printed so as to be arranged on the back surface thereof, and that when these two sheets are bound with top binding, a product in which the first page of the original images is arranged on the entire inner surface of a top and bottom spread, and the image on the second page of the original images is arranged on the outer surface is obtained as illustrated by the final product.

An example of reference numeral 1006 illustrates a case where the printing style 911 is double-sided 913, input documents are portrait, “arrange from outer surface” is performed instead of “arrange from inner surface” due to the checkbox 914 not being checked, and top binding is performed. It is illustrated that, in this case, compared to the case of reference numeral 1005, the first page and the second page of original images are switched, the bottom half (B) of an image on the first page of the original images is printed so as to be arranged on the front surface of the first sheet, and the top half (C) of an image on the second page of the original images is printed so as to be arranged on the back surface thereof, that then the bottom half (D) of the image on the second page of the original images is printed so as to be arranged on the front surface of the second sheet, and the top half (A) of the image on the first page of the original images is printed so as to be arranged on the back surface thereof, and that when these two sheets are bound with top binding, a product in which the image on the second page of the original images is arranged on the entire inner surface of a top and bottom spread, and the image on the first page of the original images is arranged on the outer surface is obtained as illustrated by the final product.

Here, an example in which there are two pages of original images has been described, but in a case where the printing style 911 is double-sided 913 and there are three or more pages of original images, the above-described division and arrangement of original images is repeated for each set of two pages.

Next, an example in which images of a plurality of input documents are each divided and a plurality of sheets on which double-sided printing has been performed are bound as spreads will be described.

An example of reference numeral 1007 in FIG. 10C illustrates a case where the printing style 911 is bookbinding 915, input documents are landscape and open to the left, and “treat first page as front cover or back cover” is off (i.e., setting for a front cover and a back cover is not performed) due to the checkbox 916 not being checked. In this case, the left half (1L) of an image on the first page of original images is printed so as to be arranged on the back surface of the first sheet, the right half (1R) of the image on the first page of the original images is printed so as to be arranged on the front surface of the second sheet, and the left half (2L) of the second page of the original images is printed so as to be arranged on the back surface thereof. Then, the right half (2R) of an image on the second page of the original images is printed so as to be arranged on the front surface of the third sheet, and the left half (3L) of an image on the third page of the original images is printed so as to be arranged on the back surface thereof. In addition, the right half (3R) of the image on the third page of the original images is printed so as to be arranged on the front surface of the fourth sheet, and these four sheets on which double-sided printing has been performed are bound so as to open to the left. With this, a product in which the original images are arranged in the order of pages on respective spread surfaces is obtained as illustrated by the final product.

An example of reference numeral 1008 illustrates a case where the printing style 911 is bookbinding 915, input documents are landscape and open to the left, and the first page is treated as a front cover or a back cover due to the checkbox 916 being checked. In this case, compared to the case of reference numeral 1007 described above, the right half of an image on the first page of original images is treated as a front cover, and the left half is treated as a back cover. The right half (front cover) of the image on the first page of the original images is printed so as to be arranged on the front surface of the first sheet, and the left half (back cover) of the image on the first page of the original images is printed so as to be arranged on the back surface of the last sheet. As for the other sheets, images of the original images are arranged and the sheets are bound so as to open to the left as in the case of the previous reference numeral 1007. As illustrated by the final product, this results in the original images being arranged in the order of pages on respective spread surfaces with the front cover and the back cover.

An example of reference numeral 1009 illustrates a case where the printing style 911 is bookbinding 915, input documents are landscape and open to the right, and “treat first page as front cover or back cover” is off (i.e., setting for a front cover and a back cover is not performed) due to the checkbox 916 not being checked. In this case, compared to the case of the reference numeral 1007, left and right parts of original images are arranged so as to be switched. That is, the right half (1R) of an image on the first page of original images is arranged on the back surface of the first sheet, the left half (1L) of the image on the first page of the original images is arranged on the front surface of the second sheet, and the right half (2R) of an image on the second page of the original images is arranged on the back surface thereof. Then, the left half (2L) of the image on the second page of the original images is printed so as to be arranged on the front surface of the third sheet, the right half (3R) of an image on the third page of the original images is printed so as to be arranged on the back surface thereof, and the left half (3L) of the image on the third page of the original images is printed so as to be arranged on the front surface of the fourth sheet. Then, when the four printed sheets are bound so as to open to the right, a product in which the original images are arranged in the order of pages on respective spread surfaces is obtained as illustrated by the final product.

An example of reference numeral 1010 illustrates a case where the printing style 911 is bookbinding 915, input documents are portrait and open to the top, and “treat first page as front cover or back cover” is off (i.e., setting for a front cover and a back cover is not performed) due to the checkbox 916 not being checked. In this case, the top half (1T) of an image on the first page of original images is arranged on the back surface of the first sheet, the bottom half (1B) of the image on the first page of the original images is arranged on the front surface of the second sheet, and the top half (2T) of an image on the second page of the original images is arranged on the back surface thereof. Then, the bottom half (2B) of the image on the second page of the original images is printed so as to be arranged on the front surface of the third sheet, the top half (3T) of an image on the third page of the original images is printed so as to be arranged on the back surface thereof, and the bottom half (3B) of the image on the third page of the original images is printed so as to be arranged on the front surface of the fourth sheet. When the four sheets thus printed are bound so as to open to the top, this results in the original images being arranged in the order of pages on respective spread surfaces as illustrated by the final product.

Although not illustrated in FIG. 10C, in the case where “treat first page as front cover or back cover” is performed due to the checkbox 916 being checked, the left half of an image on the first page of original images is treated as a front cover and the right half is treated as a back cover. Then, the left half (front cover) of the image on the first page of the original images is arranged on the front surface of the first sheet, and the right half (back cover) of the image on the first page of the original images is arranged on the back surface of the last sheet. Then, others are printed with the above-described arrangement, thereby making it possible to obtain a final product with a front cover and a back cover.

Here, an example in which there are three pages or, including a front cover and a back cover, four pages of original images has been described, but even if the printing style 911 is bookbinding 915 and there are three or more pages of original images, it is possible to handle that by repeatedly arranging divided original images in the order of a back surface and a front surface.

Further, a configuration may be taken so as to, when the size of an original image is not a size of two output sheets arranged side by side, for example, enlarge or reduce a size of the original image bisected into left and right parts or top and bottom parts, to the size of an output sheet and perform output. For example, if an original image is in an A3 size and an output sheet is in an A4 size, half the size of the original image is equal to A4, so there is no need to enlarge or reduce the image. However, if an original image is in the A4 size and an output sheet is also in the A4 size, half the size of the original image needs to be enlarged (√2 times≈144%) to be in the A4 size, which is the output sheet size.

Next, processing by the printer driver according to the embodiment will be described. As previously described, the printer driver generates print information including a print setting command for performing printing and a drawing command for printing is called from a document program (application) installed in the same PC 100. The print information generated by the printer driver is transmitted to the image forming apparatus 1100 through the communication line 150 by the OS, and printing and sheet processing are performed. Original images in page units created by the document program are divided by the printer driver and, if there is no enlargement or reduction of the images, are converted into print information instructing printing onto sheets that are half the size of the original images and transmitted to the image forming apparatus 1100.

For example, assume a case where, when there is one page of an A3-sized original image created by the document program and for which printing has been instructed to the printer driver and spread printing is set, the printing style 911 is single-sided 912 and enlargement or reduction is not performed. In this case, the printer driver generates, for the image forming apparatus 1100, four pages (front and back combined, including blank sheets) of print information in the A4 size, which is half of the original image.

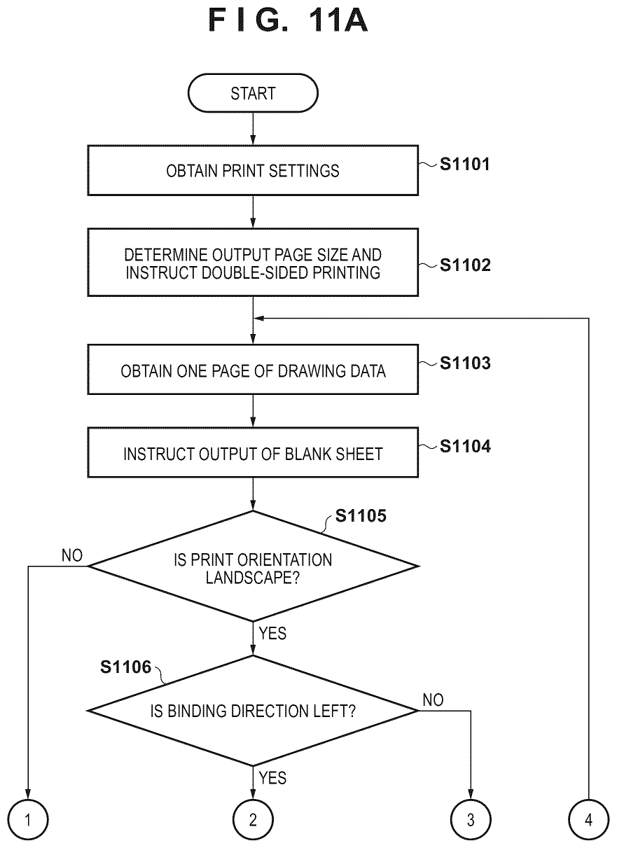

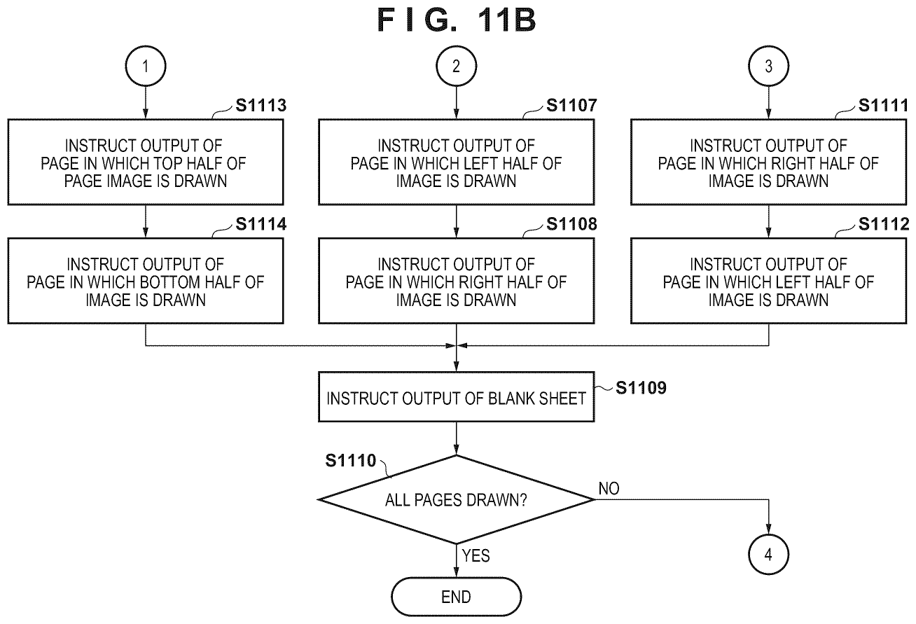

FIGS. 11A and 11B are flowcharts for explaining print information generation processing for when the printing style 911 is single-sided 912, according to the printer driver according to the embodiment. The processing described in this flowchart is realized by the printer driver, which is a print control program stored in the ROM 23 or the HDD 28, being deployed into the RAM 22 and executed by the CPU 21.

First, in step S1101, the CPU 21 obtains print setting information set through the print setting screens 700 and 900 described above. The print setting information includes settings such as the printing style 911 (which is an advanced setting for when the page layout 706 is the spread 901), the binding direction 708, the document size 701, the output sheet size 702, and the print orientation 705. Next, the processing proceeds to step S1102, and the CPU 21 references the document size 701 and the output sheet size 702 included in the print setting information and issues a command to instruct a page size at which to perform output and double-sided printing to the image forming apparatus 1100. The processing proceeds to step S1103, and the CPU 21 receives one page of drawing data from the document creation program and the processing proceeds to step S1104.

In step S1104, the CPU 21 creates the front surface of a first sheet by issuing a drawing command for outputting a blank sheet to the image forming apparatus 1100 in order to issue a page corresponding to the front surface of a sheet. Then, the processing proceeds to step S1105, and the CPU 21 determines whether the print orientation of an original image is landscape and, if the print orientation is landscape, the processing proceeds to step S1106 and the CPU 21 determines whether the binding direction is left. Here, if it is determined that the binding direction is left, the processing proceeds to step S1107, and if it is determined that the binding direction is right, the processing proceeds to step S1111. In step S1105, if the print orientation of the original image is not landscape (i.e., if the print orientation is portrait), the processing proceeds to step S1113 (FIG. 11B). In step S1113, the CPU 21 creates the back surface of the first sheet by instructing issuance of a command to arrange and draw an image of the top half of the page obtained in step S1103 on one page. Then, in step S114, the CPU 21 creates the front surface of a second sheet by instructing issuance of a command to draw an image of the bottom half of the next page and proceeds to step S1109. This corresponds to the case indicated by reference numeral 1002 of FIG. 10A.

If the print orientation of the original image is landscape and in the case of left-side binding, the processing proceeds to step S1107 (FIG. 11B), and the CPU 21 creates the back surface of the first sheet by instructing issuance of a command to draw an image of the left half of the page obtained in step S1103 on one page. Next, the processing proceeds to step S1108, and the CPU 21 creates the front surface of a second sheet by instructing issuance of a command to draw an image of the right half of that page on another page and the processing proceeds to step S1109. This corresponds to the case indicated by reference numeral 1001 of FIG. 10A.

If the print orientation of the original image is landscape and in the case of right-side binding, the processing proceeds to step S1111 (FIG. 11B), and the CPU 21 creates the back surface of the first sheet by instructing issuance of a command to draw an image of the right half of the page obtained in step S1103 on one page. Next, the processing proceeds to step S1112, and the CPU 21 creates the front surface of a second sheet by instructing issuance of a command to draw an image of the left half of the page obtained in step S1103 on another page and the processing proceeds to step S1109. In step S1109, the CPU 21 creates the back surface of the second sheet by instructing issuance of a drawing command for outputting a blank sheet to the image forming apparatus 1100. Then, the processing proceeds to step S1110, and the CPU 21 determines whether all pages created by the document creation program have been processed and, if there is a page that has not yet been processed, returns to step S1103 and repeats the above processing. When all pages are thus processed, the print information generation processing by the printer driver is terminated.

As described above, according to the embodiment, by adhering the created first sheet and second sheet at a designated binding position, it is possible to obtain a printed matter in which the original image is arranged on the entire surface of a spread on the inner side.

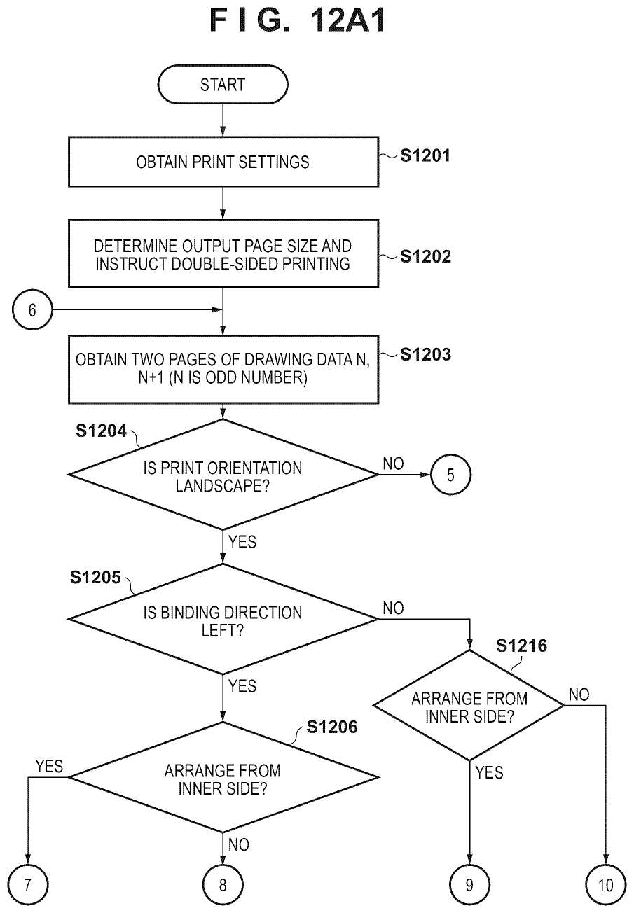

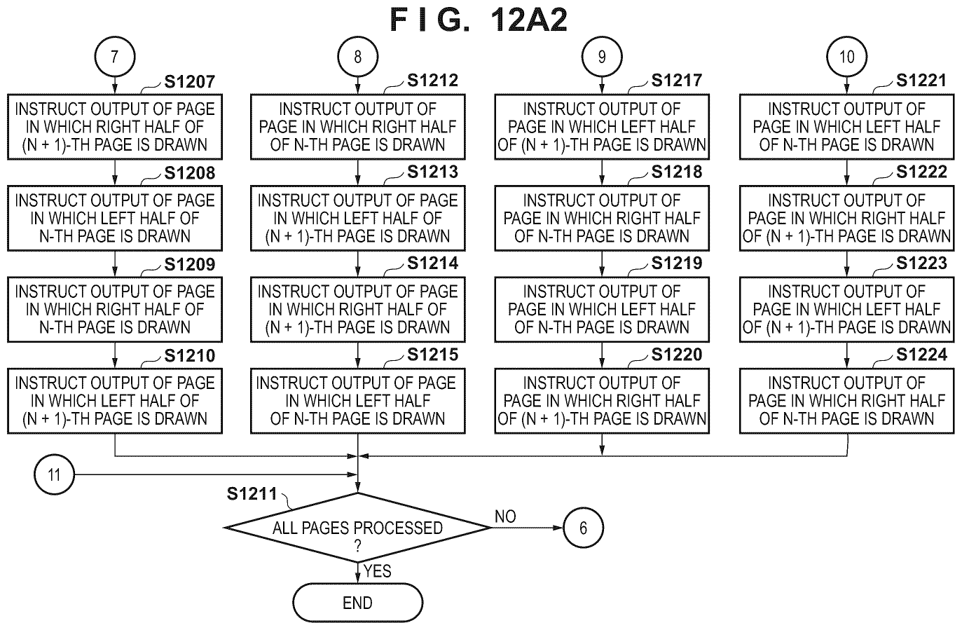

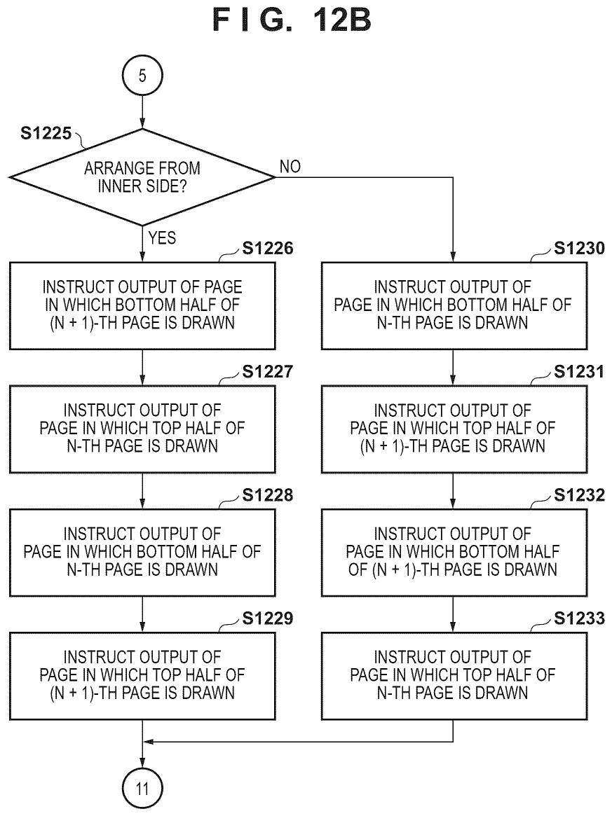

FIGS. 12A1, 12A2 and 12B are flowcharts for explaining print information generation processing for when the printing style 911 is double-sided 913, according to the printer driver according to the embodiment. The processing described in this flowchart is realized by the printer driver, which is a print control program stored in the ROM 23 or the HDD 28, being deployed into the RAM 22 and executed by the CPU 21.

First, in step S1201, the CPU 21 obtains print setting information set through the print setting screens 700 and 900 described above. The print setting information includes settings such as the printing style 911 (which is an advanced setting for when the page layout 706 is the spread 901), the binding direction 708, the document size 701, the output sheet size 702, and the print orientation 705. Next, the processing proceeds to step S1202, and the CPU 21 references the document size 701 and the output sheet size 702 included in the print setting information and issues a command to instruct a page size at which to perform output and double-sided printing to the image forming apparatus 1100. Next, the processing proceeds to step S1203, and the CPU 21 receives two pages of drawing data from the document creation program. The pages obtained here will respectively be described as an N-th page and an (N+1)-th page (N is an odd number). If the total number of pages created by the document creation program is an odd number, the (N+1)-th page cannot be obtained. In this case, the (N+1)-th page is treated as a blank sheet in the subsequent processing. Next, the processing proceeds to step S1204, and the CPU 21 determines whether the print orientation of original images is landscape and, if the print orientation is landscape, the processing proceeds to step S1205 and the CPU 21 determines whether the binding direction is left. If the binding direction is left, the processing proceeds to step S1206, and the CPU 21 determines whether “arrange from inner surface” is set in the checkbox 914. In step S1206, if it is determined that “arrange from inner surface” is set, the processing proceeds to step S1207, and otherwise, the processing proceeds to step S1212. In step S1205, if it is determined that the binding direction is right, the processing proceeds to step S1216.

If the print orientation of original images is landscape and in the case of left-side binding and “arrange from inner surface” in this way, the processing proceeds to step S1207, and the CPU 21 creates the front surface of a first sheet by instructing issuance of a command to draw an image of the right half of the (N+1)-th page obtained in step S1203 on one page. Next, the processing proceeds to step S1208, and the CPU 21 creates the back surface of the first sheet by instructing issuance of a command to draw an image of the left half of the N-th page on one page. Next, the processing proceeds to step S1209, and the CPU 21 creates the front surface of a second sheet by issuing a command to draw an image of the right half of the N-th page on one page. Next, the processing proceeds to step S1210, and the CPU 21 creates the back surface of the second sheet by instructing issuance of a command to draw an image of the left half of the (N+1)-th page on one page and the processing proceeds to step S1211. This corresponds to the case indicated by reference numeral 1003 of FIG. 10B.

If the print orientation of original images is landscape and in the case of left-side binding and “arrange from outer surface” due to the checkbox 914 not being checked, the processing proceeds to step S1212. In step S1212, the CPU 21 creates the front surface of a first sheet by instructing issuance of a command to draw an image of the right half of the N-th page obtained in step S1203 on one page. Next, the processing proceeds to step S1213, and the CPU 21 creates the back surface of the first sheet by instructing issuance of a command to draw an image of the left half of the (N+1)-th page on one page. Then, the processing proceeds to step S1214, and the CPU 21 creates the front surface of a second sheet by issuing a command to draw an image of the right half of the (N+1)-th page on one page. Next, the processing proceeds to step S1215, and the CPU 21 creates the back surface of the second sheet by instructing issuance of a command to draw an image of the left half of the N-th page on one page and the processing proceeds to step S1211. This corresponds to the case indicated by reference numeral 1004 of FIG. 10B.

If the print orientation of original images is landscape and in the case of right-side binding and “arrange from inner surface” due to the checkbox 914 being checked in step S1216, the processing proceeds to step S1217. In step S1217, the CPU 21 creates the front surface of a first sheet by instructing issuance of a command to draw an image of the left half of the (N+1)-th page obtained in step S1203 on one page. Next, the processing proceeds to step S1218, and the CPU 21 creates the back surface of the first sheet by instructing issuance of a command to draw an image of the right half of the N-th page on one page. Next, the processing proceeds to step S1219, and the CPU 21 creates the front surface of a second sheet by issuing a command to draw an image of the left half of the N-th page on one page. Next, the processing proceeds to step S1220, and the CPU 21 creates the back surface of the second sheet by instructing issuance of a command to draw an image of the right half of the (N+1)-th page on one page and the processing proceeds to step S1211.

In the case of “arrange from outer surface” due to the checkbox 914 not being checked in step S1216, the processing proceeds to step S1221. In step S1221, the CPU 21 creates the front surface of a first sheet by instructing issuance of a command to draw an image of the left half of the N-th page obtained in step S1203 on one page. Next, the processing proceeds to step S1222, and the CPU 21 creates the back surface of the first sheet by instructing issuance of a command to draw an image of the right half of the (N+1)-th page on one page. Next, the processing proceeds to step S1223, and the CPU 21 creates the front surface of a second sheet by issuing a command to draw an image of the left half of the (N+1)-th page on one page. Next, the processing proceeds to step S1224, and the CPU 21 creates the back surface of the second sheet by instructing issuance of a command to draw an image of the right half of the N-th page on one page and the processing proceeds to step S1211.

Next, a case where the print orientation of original images are portrait will be described with reference to FIG. 12B. If the print orientation of original images is portrait in step S1204, the processing proceeds to step S1225 (FIG. 12B). In step S1225, in the case of “arrange from outer surface” due to the checkbox 914 not being checked, the processing proceeds to step S1226. In step S1226, the CPU 21 creates the front surface of a first sheet by instructing issuance of a command to draw an image of the bottom half of the (N+1)-th page obtained in step S1203 on one page. Next, the processing proceeds to step S1227, and the CPU 21 creates the back surface of the first sheet by instructing issuance of a command to draw an image of the top half of the N-th page on one page. Next, the processing proceeds to step S1228, and the CPU 21 creates the front surface of a second sheet by issuing a command to draw an image of the bottom half of the N-th page on one page. Then, the processing proceeds to step S1229, and the CPU 21 creates the back surface of the second sheet by instructing issuance of a command to draw an image of the top half of the (N+1)-th page on one page and the processing proceeds to step S1211.

In step S1225, in the case of “arrange from outer surface” due to the checkbox 914 not being checked, the processing proceeds to step S1230. In step S1230, the CPU 21 creates the front surface of a first sheet by instructing issuance of a command to draw an image of the bottom half of the N-th page obtained in step S1203 on one page. Next, the processing proceeds to step S1231, and the CPU 21 creates the back surface of the first sheet by instructing issuance of a command to draw an image of the top half of the (N+1)-th page on one page. Then, the processing proceeds to step S1232, and the CPU 21 creates the front surface of a second sheet by issuing a command to draw an image of the bottom half of the (N+1)-th page on one page. Then, the processing proceeds to step S1233, and the CPU 21 creates the back surface of the second sheet by instructing issuance of a command to draw an image of the top half of the N-th page on one page and the processing proceeds to step S1211.

In step S1211, the CPU 21 determines whether all pages created by the document creation program have been processed and, if there is a page that has not yet been processed, returns to step S1203 and repeats the above processing. In step S1211, if all pages are thus processed, the printer driver print information generation processing by the CPU 21 is terminated.

By adhering the first sheet and the second sheet created as described above at a binding position, it is possible to obtain a printed matter in which the original images are each arranged on the surface of a spread on the inner side or on the outer surface.

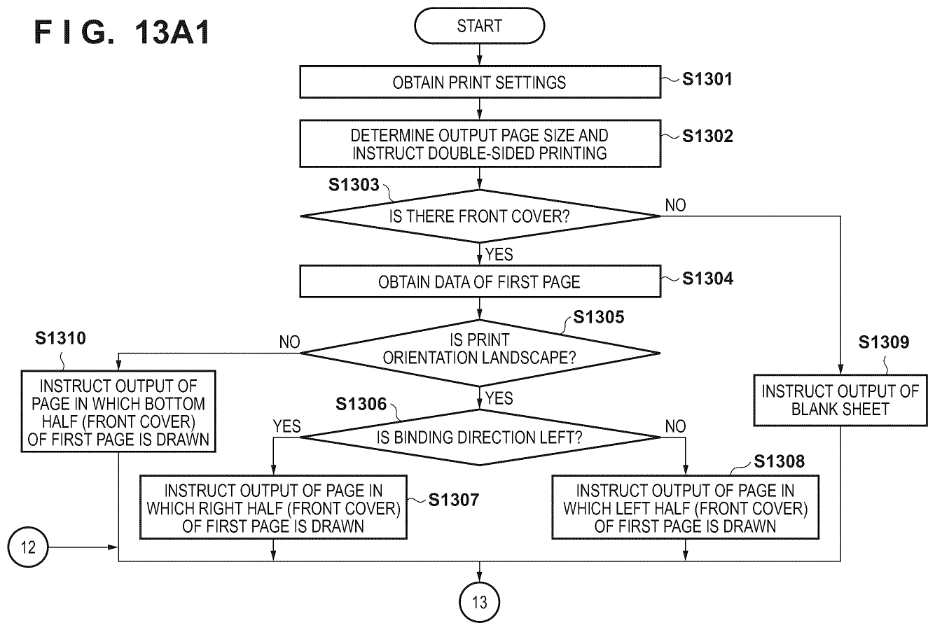

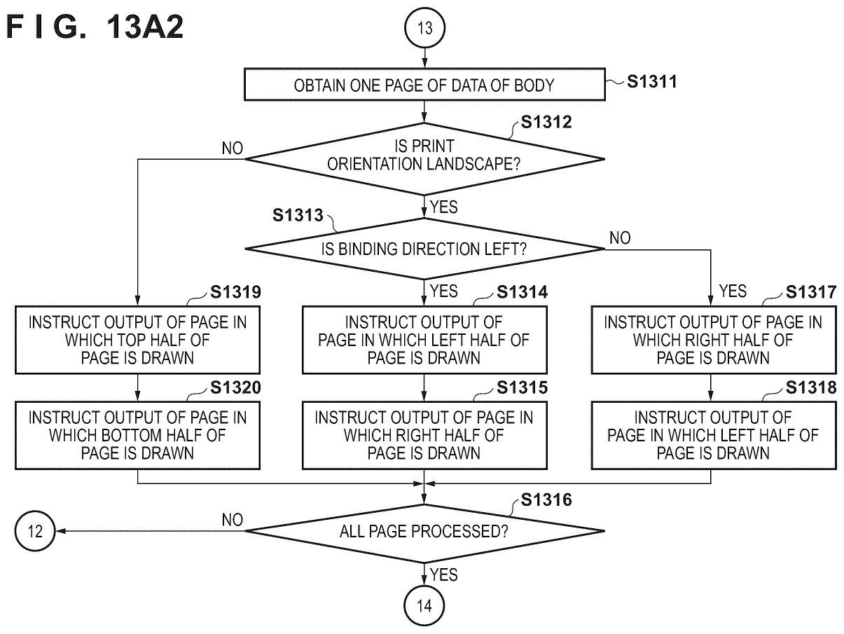

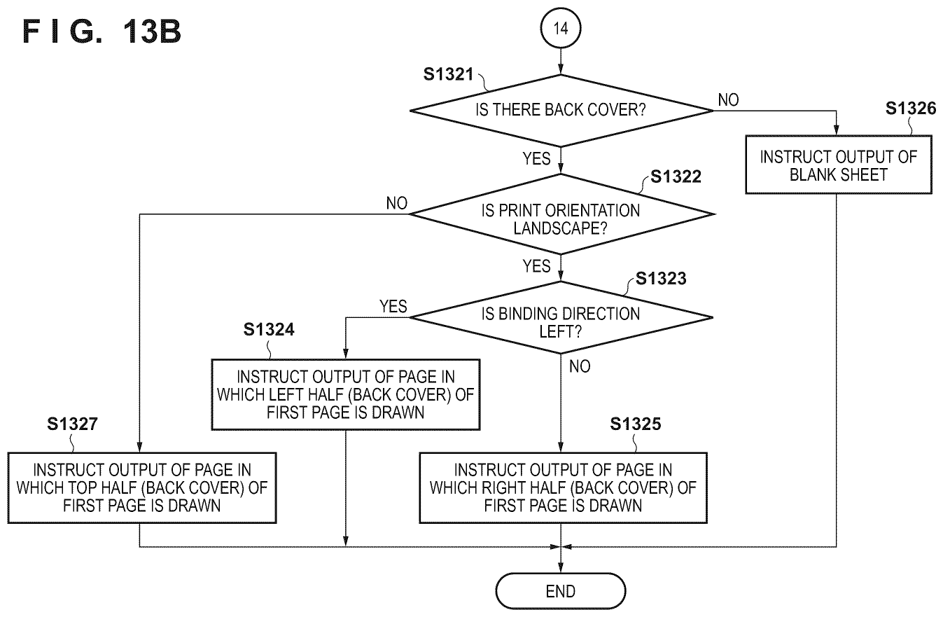

FIGS. 13A1, 13A2 and 13B are flowcharts for explaining print information generation processing for when the printing style 911 is bookbinding 915, according to the printer driver according to the embodiment. The processing described in this flowchart is realized by the printer driver, which is a print control program stored in the ROM 23 or the HDD 28, being deployed into the RAM 22 and executed by the CPU 21.

First, in step S1301, the CPU 21 obtains print setting information set through the print setting screens 700 and 900 described above. The print setting information includes settings such as the printing style 911 (which is an advanced setting for when the page layout 706 is the spread 901) and the binding direction 708, the document size 701, the output sheet size 702, and the print orientation 705 of FIG. 7A. Next, the processing proceeds to step S1302, and the CPU 21 references the document size 701 and the output sheet size 702 included in the print settings and issues a command to instruct a page size at which to perform output and double-sided printing to the image forming apparatus 1100.

Next, the processing proceeds to step S1303, and the CPU 21 determines whether there is a front cover setting. At this time, if the checkbox 916 is set to “treat first page as front cover or back cover” in the screen 910 of FIG. 9B, it is determined that there is a front cover, and if it is not set, it is determined that there is no front cover. In step S1303, if it is determined that there is no front cover setting, the processing proceeds to step S1309, and the CPU 21 issues a drawing command for outputting a blank sheet to the image forming apparatus 1100 in order to issue a page corresponding to a front cover, thereby creating the front surface of a first sheet, and the processing proceeds to step S1311.

Meanwhile, in step S1303, when it is determined that there is a front cover setting, the processing proceeds to step S1304 and the CPU 21 receives drawing data of the first page from the document creation program. Next, the processing proceeds to step S1305, and the CPU 21 determines whether the print orientation of image data of the first page, which is an original image, is landscape. If the print orientation is landscape, the processing proceeds to step S1306, and the CPU 21 determines whether the binding direction is left. In this way, it is determined which part of the drawing data obtained in step S1304 to treat as an image of the front cover, and a command for drawing the image of the front cover on one page is issued to the image forming apparatus 1100. In step S1305, if it is determined that the print orientation of the original image is portrait, the processing proceeds to step S1310, and the CPU 21 treats the bottom half of the page as the image of the front cover, instructs issuance of a command to draw that image on one page, and proceeds to step S1311.

If it is determined in step S1305 that the print orientation of the original image is landscape and in step S1306 that the binding direction is left, the CPU 21 proceeds to step S1307. In step S1307, the CPU 21 treats the right half of the first page as the image of the front cover, instructs issuance of a command to draw that image on one page, and proceeds to step S1311. In step S1306, if it is determined that the binding direction is right, the processing proceeds to step S1308, and the CPU 21 treats the left half of the page as the image of the front cover, instructs issuance of a command to draw that image on one page, and proceeds to step S1311.

In step S1311, the CPU 21 obtains one page of body drawing data from the document creation program. Then, the processing proceeds to step S1312, and similarly to the previous case of the front cover, the CPU 21 determines whether the print orientation of the body drawing data, which is the original image obtained in step S1311, is landscape and, in step S1313, determines whether the binding direction is left. In this way, it is determined which part of the drawing data obtained in step S1311 to arrange on which surface of which sheet, and a command for drawing a corresponding image on one page is issued to the image forming apparatus 1100. Further, in step S1312, when it is determined that the print orientation of the original image is portrait, the processing proceeds to step S1319 and the CPU 21 creates the back surface of the sheet by instructing issuance of a command to draw an image of the top half of the page on one page. Then, the processing proceeds to step S1320, and the CPU 21 creates the front surface of the next sheet by instructing issuance of a command to draw an image of the bottom half of the page on one page and the processing proceeds to step S1316.

If it is determined in step S1312 that the print orientation of the original image is landscape and in step S1313 that the binding direction is left, the processing proceeds to step S1314 and the CPU 21 creates the back surface of the sheet by instructing issuance of a command to draw an image of the left half of the page on one page. Next, the processing proceeds to step S1315, and the CPU 21 creates the front surface of the next sheet by instructing issuance of a command to draw an image of the right half of the page on one page and the processing proceeds to step S1316. Further, in step S1313, when it is determined that the binding direction is right, the processing proceeds to step S1317 and the CPU 21 creates the back surface of the sheet by instructing issuance of a command to draw an image of the right half of the page on one page. Next, the processing proceeds to step S1318, and the CPU 21 creates the front surface of the next sheet by instructing issuance of a command to draw an image of the left half of the page on one page and the processing proceeds to step S1316. In step S1316, the CPU 21 determines whether all pages created by the document creation program have been processed and, if there is a page that has not yet been processed, the processing returns to step S1311 and the CPU 21 repeats the above processing. If there are no unprocessed pages, the processing proceeds to step S1321 (FIG. 13B) and determines whether a back cover is set.

In step S1321, if “treat first page as front cover or back cover” is set due to the checkbox 916 being checked, the CPU 21 determines that there is a back cover, and if it is not set, the CPU 21 determines that there is no back cover. In step S1321, if it is determined that there is no back cover setting, the processing proceeds to step S1326, and the CPU 21 issues a drawing command for outputting a blank sheet to the image forming apparatus 1100 in order to issue a page corresponding to a back cover, thereby creating the back surface of the last sheet, and ends the processing.

Meanwhile, if it is determined that there is a back cover setting, the processing proceeds to step S1322, and the CPU 21 determines whether the print orientation of the first page of the drawing data, which is the original image obtained in step S1304, is landscape and, in step S1323, determines whether the binding direction is left. It is determined which part of the drawing data obtained in step S1304 to treat as an image of the back cover according to these determination results, and a command for drawing the image of the back cover on one page is issued to the image forming apparatus 1100. In step S1322, if the print orientation of the original image is portrait, the processing proceeds to step S1327, and the CPU 21 treats the top half of the page as the image of the back cover, instructs issuance of a command to draw that image on one page, and ends the processing.

Further, in step S1322, if it is determined that the print orientation of the original image is landscape, the processing proceeds to step S1323, and if it is determined that the binding direction is left, the processing proceeds to step S1324. In step S1324, the CPU 21 treats the left half of the first page as the image of the back cover, instructs issuance of a command to draw that image on one page, and ends the processing. In step S1323, if it is determined that the binding direction is right, the processing proceeds to step S1325, and the CPU 21 treats the right half of the first page as the image of the back cover, instructs issuance of a command to draw that image on one page, and ends the processing.

By adhering adjacent sheets, which have been created as described above, at a designated binding position, it is possible to obtain a printed matter in a bookbinding format in which the original image is arranged on respective spread surfaces.

### Other Embodiments

Embodiments of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer-executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2023-123764, which was filed on Jul. 28, 2023 and which is hereby incorporated by reference herein in their entirety.

What is claimed is:

1. A non-transitory-computer readable storage medium storing a printer driver program for causing a processor to receive drawing data from an application and generate print information, wherein the printer driver program is configured to cause the processor to:
obtain a print setting inputted via a setting screen for performing print setting;
in a case where the print setting includes a spread setting, divide an original image of a page represented by the drawing data into a first image and a second image; and
control arrangement of the first image and the second image on a first sheet and a second sheet according to a binding position for binding a plurality of printed sheets using a printing material and an orientation of the original image, which are included in the print setting.

2. The non-transitory-computer readable storage medium according to claim 1, wherein, in the division, the printer driver program is configured to cause the processor to:
in a case where the original image is an image in a landscape orientation, bisect the original image into left and right parts as the first image and the second image, and
in a case where the original image is an image in a portrait orientation, bisect the original image into top and bottom parts as the first image and the second image.

3. The non-transitory-computer readable storage medium according to claim 1, wherein, in the control of arrangement of the first image and the second image, the printer driver program is configured to cause the processor to:
perform arrangement such that the original image is formed on a respective spread surface in a case that a plurality of sheets are bound at the binding position.

4. The non-transitory-computer readable storage medium according to claim 2, wherein, in the control of arrangement of the first image and the second image, the printer driver program is configured to cause the processor to:
in a case where the original image is an image in a landscape orientation and the binding position is left-side binding, arrange the first image and the second image for which the original image has been bisected into left and right parts on a back surface of the first sheet and a front surface of the second sheet, respectively.

5. The non-transitory-computer readable storage medium according to claim 4, wherein, in the control of arrangement of the first image and the second image, the printer driver program is configured to cause the processor to:
in a case where the original image is an image in a landscape orientation and the binding position is right-side binding, arrange the first image on the front surface of the second sheet and arrange the second image on the back surface of the first sheet.

6. The non-transitory-computer readable storage medium according to claim 2, wherein, in the control of arrangement of the first image and the second image, the printer driver program is configured to cause the processor to:
in a case where the original image is an image in a portrait orientation and the binding position is top binding, arrange the first image and the second image for which the original image has been bisected into top and bottom parts on a back surface of the first sheet and a front surface of the second sheet, respectively.

7. The non-transitory-computer readable storage medium according to claim 1, wherein the print setting further includes a setting as to whether to perform arrangement from an inner surface for the spread setting, and in the control of arrangement of the first image and the second image, the printer driver program is configured to cause the processor to:
switch images to be arranged on the first sheet and the second sheet between a case where the setting is a setting for performing arrangement from the inner surface and a case where that is not the case.

8. An information processing apparatus operable to generate print information based on drawing data generated by an application and output the print information to a printing apparatus, the information processing apparatus comprising:
one or more controllers including one or more processors and one or more memories, the one or more controllers configured to:
obtain a print setting inputted via a setting screen for performing print setting;
in a case where the print setting includes a spread setting, divide an original image of a page represented by the drawing data into a first image and a second image; and
control arrangement of the first image and the second image on a first sheet and a second sheet according to a binding position for binding a plurality of printed sheets using a printing material and an orientation of the original image, which are included in the print setting.

9. The information processing apparatus according to claim 8, wherein in the division, the one or more controllers are configured to:
in a case where the original image is an image in a landscape orientation, bisect the original image into left and right parts as the first image and the second image, and
in a case where the original image is an image in a portrait orientation, bisect the original image into top and bottom parts as the first image and the second image.

10. The information processing apparatus according to claim 8, wherein, in the control of arrangement of the first image and the second image, the one or more controllers are configured to:
perform arrangement such that the original image is formed on a respective spread surface in a case that a plurality of sheets are bound at the binding position.

11. The information processing apparatus according to claim 9, wherein, in the control of arrangement of the first image and the second image, the one or more controllers are configured to:
in a case where the original image is an image in a landscape orientation and the binding position is left-side binding, arrange the first image and the second image for which the original image has been bisected into left and right parts on a back surface of the first sheet and a front surface of the second sheet, respectively.

12. The information processing apparatus according to claim 11, wherein, in the control of arrangement of the first image and the second image, the one or more controllers are configured to:
in a case where the original image is an image in a landscape orientation and the binding position is right-side binding, arrange the first image on the front surface of the second sheet and arrange the second image on the back surface of the first sheet.

13. The information processing apparatus according to claim 9, wherein, in the control of arrangement of the first image and the second image, the one or more controllers are configured to:
in a case where the original image is an image in a portrait orientation and the binding position is top binding, arrange the first image and the second image for which the original image has been bisected into top and bottom parts on a back surface of the first sheet and a front surface of the second sheet, respectively.

14. The information processing apparatus according to claim 8, wherein the print setting further includes a setting as to whether to perform arrangement from an inner surface for the spread setting, and, in the control of arrangement of the first image and the second image, the one or more controllers are configured to:
switch images to be arranged on the first sheet and the second sheet between a case where the setting is a setting for performing arrangement from the inner surface and a case where that is not the case.

15. A method of controlling an information processing apparatus operable to generate print information based on drawing data generated by an application and output the print information to a printing apparatus, the method comprising:
obtaining a print setting inputted via a setting screen for performing print setting;
in a case where the print setting includes a spread setting, dividing an original image of a page represented by the drawing data into a first image and a second image; and
controlling arrangement of the first image and the second image on a first sheet and a second sheet according to a binding position for binding a plurality of printed sheets using a printing material and an orientation of the original image, which are included in the print setting.
